(19) United States
(12) Patent Application Publication
(10) Pub. No.: US 2025/0291858 A1
(43) Pub. Date: Sep. 18, 2025

(54) DEVICE, SYSTEM AND METHOD FOR EFFICIENT OPERATION OF A LARGE LANGUAGE MODEL ENGINE IN CONJUNCTION WITH A PROGRAMMATIC SEARCH ENGINE

(71) Applicant: AMADEUS S.A.S., Biot (FR)

(72) Inventors: Maxime Alain Dominique PETER, Cannes (FR); Léa PISAN, Vallauris (FR); Thomas PALANDRI, Antibes (FR); Kevin YEP, Antibes (FR)

(21) Appl. No.: 19/057,437

(22) Filed: Feb. 19, 2025

(30) Foreign Application Priority Data
Mar. 15, 2024 (EP) 24305390.7

(51) Int. Cl. G06F 16/953; G06F 18/241

(52) U.S. Cl. CPC G06F 16/953; G06F 18/241

(57) ABSTRACT

A computing device receives, from a client device, a textual inquiry, and provides it to a programmatic search engine that compares the textual inquiry to previously stored textual inquiries. The computing device receives, from the programmatic search engine, one or more of respective related textual responses with respective comparison scores between the textual inquiry and associated stored textual inquiries and, based on the respective comparison scores, provides at least the textual inquiry to a large language model (LLM) engine. The computing device receives, from the LLM engine, an LLM response to the textual inquiry, provides the LLM response to the client device, which provides feedback thereon. When the feedback meets a storage criteria, the computing device provides, to the programmatic search engine, the textual inquiry and the LLM response for storage and use in generating responses to later textual inquiries.

### FIELD

The specification relates generally to large language models, and specifically to a device, system and method for efficient operation of a large language model engine in conjunction with a programmatic search engine.

### BACKGROUND

Programmatic search engines, such as chatbots engines, generally rely on predetermined responses that may be found using keywords, and the like, in textual inquiries to the programmatic search engines. While a large language model engine could be used in place of a programmatic search engine, for example to allow for more types of responses, responses from large language model engines may be slower to generate than from a programmatic search engine. Furthermore implementing such large language model engines tends to come with higher processing overhead than with implementing programmatic search engines.

### SUMMARY

A first aspect of the present specification provides a method comprising: receiving, at a computing device, from a client device, a textual inquiry; providing, via the computing device, the textual inquiry to a programmatic search engine that compares the textual inquiry to previously stored textual inquiries, the previously stored textual inquiries stored in association with respective related textual responses; receiving, via the computing device, from the programmatic search engine, one or more of the respective related textual responses with respective comparison scores between the textual inquiry and associated stored textual inquiries; based on the respective comparison scores, providing, via the computing device, at least the textual inquiry to a large language model (LLM) engine; receiving, via the computing device, from the LLM engine, an LLM response to the textual inquiry; providing, via the computing device, to the client device, the LLM response; receiving, via the computing device, from the client device, feedback on the LLM response; and when the feedback meets a storage criteria, providing, via the computing device, to the programmatic search engine, the textual inquiry and the LLM response for storage and use in generating responses to later textual inquiries.

The method of the first aspect may further comprise: after receiving the LLM response: syntactically comparing the textual inquiry with previously stored textual inquiries to identify a group of one or more inquiries that are syntactically related to the textual inquiry; providing a pair of the textual inquiry and the LLM response with the group of the one or more inquiries and respective responses to the LLM engine to cause the LLM engine to classify the respective response in the group as being contradictory or not contradictory with the LLM response; determining a contradiction rate from classifications of the respective responses; and when the contradiction rate is below a threshold contradiction rate, providing, to the programmatic search engine, the textual inquiry and the LLM response for storage and use in generating responses to later textual inquiries.

The method of the first aspect may further comprise: comparing the respective comparison scores to a threshold score; and when none of the respective comparison scores meet the threshold score, providing the textual inquiry to the LLM engine comprises: providing the textual inquiry to the LLM engine without any of the respective related textual responses.

The method of the first aspect may further comprise: comparing the respective comparison scores to a threshold score; and when two or more of the respective comparison scores meet the threshold score, providing the textual inquiry to the LLM engine comprises: providing the textual inquiry to the LLM engine with the respective related textual responses associated with the two or more of the respective comparison scores meet the threshold score.

The method of the first aspect may further comprise: comparing the respective comparison scores to a threshold score; and when two or more respective comparison scores meet the threshold score, providing the textual inquiry to the LLM engine comprises: providing the textual inquiry to the LLM engine with the respective related textual responses associated with the two or more respective comparison scores meet the threshold score such that the LLM response comprises an LLM generated combination of the respective related textual responses associated with the two or more respective comparison scores meet the threshold score.

The method of the first aspect may further comprise: comparing a pair of the textual inquiry and the LLM response to pairs of the previously stored textual inquiries and the respective related textual responses to determine respective pair difference comparison scores between the pair and the pairs, and providing, to the programmatic search engine, the textual inquiry and the LLM response for storage may be further based on one or more of the respective pair difference comparison scores. At the method of the first aspect, providing, to the programmatic search engine, the textual inquiry and the LLM response for storage may occur when a smallest respective pair difference comparison score is less than a given pair storage threshold score. At the method of the first aspect, providing, to the programmatic search engine, the textual inquiry and the LLM response for storage may occur when an average of the respective pair difference comparison scores is less than a given pair storage threshold score. At the method of the first aspect, providing, to the programmatic search engine, the textual inquiry and the LLM response for storage may occur when a given number of the respective pair difference comparison scores is less than a given pair storage threshold score.

The method of the first aspect may further comprise, prior to providing the textual inquiry and the LLM response for storage: collecting, for a given time period, one or more associated textual inquiries and respective LLM responses, including the textual inquiry and the LLM response, that meet the storage criteria; determining one or more of: a number of the one or more associated textual inquiries; a variance between the respective LLM responses; and a total comparison score representing a comparison between the one or more associated textual inquiries and the respective LLM responses, and the associated stored textual inquiries and the respective related textual responses; comparing one or more of the number, the variance and the total comparison score to respective thresholds; and when the comparing meets a further storage criteria, providing, to the programmatic search engine, the one or more associated textual inquiries and the respective LLM responses, including the textual inquiry and the LLM response, for storage.

The method of the first aspect may further comprise, after the textual inquiry and the LLM response are stored: again providing the textual inquiry to the LLM engine, and receiving an updated LLM response; comparing the LLM response and the updated LLM response to determine a respective difference comparison score therebetween; when the respective difference comparison score is above a first threshold: marking the LLM response as deteriorated; and thereafter periodically generating the updated LLM response and again determining the respective difference comparison score therebetween; or when the respective difference comparison score is above a second threshold, larger than the first threshold, controlling the programmatic search engine to delete at least the LLM response.

At the method of the first aspect, a memory, accessible by the programmatic search engine, that stores the previously stored textual inquiries in association with respective related textual responses may initially empty, and the method of the first aspect may further comprise: populating the memory with one or more textual inquiries from one or more client devices and associated LLM responses from the LLM engine.

A second aspect of the specification provides a computing device comprising: a communication interface; a controller; and a computer-readable storage medium having stored thereon program instructions that, when executed by the controller, cause the controller to perform a set of operations comprising: receiving, from a client device, a textual inquiry; providing the textual inquiry to a programmatic search engine that compares the textual inquiry to previously stored textual inquiries, the previously stored textual inquiries stored in association with respective related textual responses; receiving, from the programmatic search engine, one or more of the respective related textual responses with respective comparison scores between the textual inquiry and associated stored textual inquiries; based on the respective comparison scores, providing at least the textual inquiry to a large language model (LLM) engine; receiving, from the LLM engine, an LLM response to the textual inquiry; providing, to the client device, the LLM response; receiving, from the client device, feedback on the LLM response; and when the feedback meets a storage criteria, providing, to the programmatic search engine, the textual inquiry and the LLM response for storage and use in generating responses to later textual inquiries.

At the computing device of the second aspect, the set of operations may further comprise, after receiving the LLM response: syntactically comparing the textual inquiry with previously stored textual inquiries to identify a group of one or more inquiries that are syntactically related to the textual inquiry; providing a pair of the textual inquiry and the LLM response with the group of the one or more inquiries and respective responses to the LLM engine to cause the LLM engine to classify the respective response in the group as being contradictory or not contradictory with the LLM response; determining a contradiction rate from classifications of the respective responses; and when the contradiction rate is below a threshold contradiction rate, providing, to the programmatic search engine, the textual inquiry and the LLM response for storage and use in generating responses to later textual inquiries.

At the computing device of the second aspect, the set of operations may further comprise: comparing the respective comparison scores to a threshold score; and when none of the respective comparison scores meet the threshold score, providing the textual inquiry to the LLM engine comprises: providing the textual inquiry to the LLM engine without any of the respective related textual responses.

At the computing device of the second aspect, the set of operations may further comprise: comparing the respective comparison scores to a threshold score; and when two or more of the respective comparison scores meet the threshold score, providing the textual inquiry to the LLM engine comprises: providing the textual inquiry to the LLM engine with the respective related textual responses associated with the two or more of the respective comparison scores meet the threshold score.

At the computing device of the second aspect, the set of operations may further comprise: comparing the respective comparison scores to a threshold score; and when two or more respective comparison scores meet the threshold score, providing the textual inquiry to the LLM engine comprises: providing the textual inquiry to the LLM engine with the respective related textual responses associated with the two or more respective comparison scores meet the threshold score such that the LLM response comprises an LLM generated combination of the respective related textual responses associated with the two or more respective comparison scores meet the threshold score.

At the computing device of the second aspect, the set of operations may further comprise: comparing a pair of the textual inquiry and the LLM response to pairs of the previously stored textual inquiries and the respective related textual responses to determine respective pair difference comparison scores between the pair and the pairs, and providing, to the programmatic search engine, the textual inquiry and the LLM response for storage may be further based on one or more of the respective pair difference comparison scores.

At the computing device of the second aspect providing, to the programmatic search engine, the textual inquiry and the LLM response for storage may occur when a smallest respective pair difference comparison score is less than a given pair storage threshold score. At the computing device of the second aspect providing, to the programmatic search engine, the textual inquiry and the LLM response for storage may occur when an average of the respective pair difference comparison scores is less than a given pair storage threshold score. At the computing device of the second aspect providing, to the programmatic search engine, the textual inquiry and the LLM response for storage may occur when a given number of the respective pair difference comparison scores is less than a given pair storage threshold score.

At the computing device of the second aspect, the set of operations may further comprise, prior to providing the textual inquiry and the LLM response for storage: collecting, for a given time period, one or more associated textual inquiries and respective LLM responses, including the textual inquiry and the LLM response, that meet the storage criteria; determining one or more of: a number of the one or more associated textual inquiries; a variance between the respective LLM responses; and a total comparison score representing a comparison between the one or more associated textual inquiries and the respective LLM responses, and the associated stored textual inquiries and the respective related textual responses; comparing one or more of the number, the variance and the total comparison score to respective thresholds; and when the comparing meets a further storage criteria, providing, to the programmatic search engine, the one or more associated textual inquiries and the respective LLM responses, including the textual inquiry and the LLM response, for storage.

At the computing device of the second aspect, the set of operations may further comprise, after the textual inquiry and the LLM response are stored: again providing the textual inquiry to the LLM engine, and receiving an updated LLM response; comparing the LLM response and the updated LLM response to determine a respective difference comparison score therebetween; when the respective difference comparison score is above a first threshold: marking the LLM response as deteriorated; and thereafter periodically generating the updated LLM response and again determining the respective difference comparison score therebetween; or when the respective difference comparison score is above a second threshold, larger than the first threshold, controlling the programmatic search engine to delete at least the LLM response.

At the computing device of the second aspect, a memory, accessible by the programmatic search engine, that stores the previously stored textual inquiries in association with respective related textual responses may initially empty, and the set of operations may further comprise: populating the memory with one or more textual inquiries from one or more client devices and associated LLM responses from the LLM engine.

A third aspect of the specification provides a computing device comprising: a communication interface; and a controller configured to: receive, from a client device, a textual inquiry; provide the textual inquiry to a programmatic search engine that compares the textual inquiry to previously stored textual inquiries, the previously stored textual inquiries stored in association with respective related textual responses; receive, from the programmatic search engine, one or more of the respective related textual responses with respective comparison scores between the textual inquiry and associated stored textual inquiries; based on the respective comparison scores, provide at least the textual inquiry to a large language model (LLM) engine; receive, from the LLM engine, an LLM response to the textual inquiry; provide, to the client device, the LLM response; receive, from the client device, feedback on the LLM response; and when the feedback meets a storage criteria, provide, to the programmatic search engine, the textual inquiry and the LLM response for storage and use in generating responses to later textual inquiries.

At the computing device of the third aspect, the controller may be further configured to: compare the respective comparison scores to a threshold score; and when none of the respective comparison scores meet the threshold score, provide the textual inquiry to the LLM engine by: providing the textual inquiry to the LLM engine without any of the respective related textual responses.

At the computing device of the third aspect, the controller may be further configured to: compare the respective comparison scores to a threshold score; and when two or more of the respective comparison scores meet the threshold score, provide the textual inquiry to the LLM engine by: providing the textual inquiry to the LLM engine with the respective related textual responses associated with the two or more of the respective comparison scores meet the threshold score.

At the computing device of the third aspect, the controller may be further configured to: compare the respective comparison scores to a threshold score; and when two or more respective comparison scores meet the threshold score, provide the textual inquiry to the LLM engine by: providing the textual inquiry to the LLM engine with the respective related textual responses associated with the two or more respective comparison scores meet the threshold score such that the LLM response comprises an LLM generated combination of the respective related textual responses associated with the two or more respective comparison scores meet the threshold score.

At the computing device of the third aspect, the controller may be further configured to: compare a pair of the textual inquiry and the LLM response to pairs of the previously stored textual inquiries and the respective related textual responses to determine respective pair difference comparison scores between the pair and the pairs, and providing, to the programmatic search engine, the textual inquiry and the LLM response for storage may be further based on one or more of the respective pair difference comparison scores. At the computing device of the third aspect providing, to the programmatic search engine, the textual inquiry and the LLM response for storage may occur when a smallest respective pair difference comparison score is less than a given pair storage threshold score. At the computing device of the third aspect providing, to the programmatic search engine, the textual inquiry and the LLM response for storage may occur when an average of the respective pair difference comparison scores is less than a given pair storage threshold score. At the computing device of the third aspect providing, to the programmatic search engine, the textual inquiry and the LLM response for storage may occur when a given number of the respective pair difference comparison scores is less than a given pair storage threshold score.

At the computing device of the third aspect, the controller may be further configured to, prior to providing the textual inquiry and the LLM response for storage: collect, for a given time period, one or more associated textual inquiries and respective LLM responses, including the textual inquiry and the LLM response, that meet the storage criteria; determine one or more of: a number of the one or more associated textual inquiries; a variance between the respective LLM responses; and a total comparison score representing a comparison between the one or more associated textual inquiries and the respective LLM responses, and the associated stored textual inquiries and the respective related textual responses; compare one or more of the number, the variance and the total comparison score to respective thresholds; and when the comparing meets a further storage criteria, provide, to the programmatic search engine, the one or more associated textual inquiries and the respective LLM responses, including the textual inquiry and the LLM response, for storage.

At the computing device of the third aspect, the controller may be further configured to, after the textual inquiry and the LLM response are stored: again provide the textual inquiry to the LLM engine, and receive an updated LLM response; compare the LLM response and the updated LLM response to determine a respective difference comparison score therebetween; when the respective difference comparison score is above a first threshold: mark the LLM response as deteriorated; and thereafter periodically generate the updated LLM response and again determine the respective difference comparison score therebetween; or when the respective difference comparison score is above a second threshold, larger than the first threshold, control the programmatic search engine to delete at least the LLM response.

At the computing device of the third aspect, a memory, accessible by the programmatic search engine, that stores the previously stored textual inquiries in association with respective related textual responses may initially empty, and the controller may be further configured to: populate the memory with one or more textual inquiries from one or more client devices and associated LLM responses from the LLM engine.

A fourth aspect of the specification provides a non-transitory computer-readable storage medium having stored thereon program instructions that, when executed by a computing device, cause the computing device to perform a set of operations comprising: receiving, from a client device, a textual inquiry; providing the textual inquiry to a programmatic search engine that compares the textual inquiry to previously stored textual inquiries, the previously stored textual inquiries stored in association with respective related textual responses; receiving, from the programmatic search engine, one or more of the respective related textual responses with respective comparison scores between the textual inquiry and associated stored textual inquiries; based on the respective comparison scores, providing at least the textual inquiry to a large language model (LLM) engine; receiving, from the LLM engine, an LLM response to the textual inquiry; providing, to the client device, the LLM response; receiving, from the client device, feedback on the LLM response; and when the feedback meets a storage criteria, providing, to the programmatic search engine, the textual inquiry and the LLM response for storage and use in generating responses to later textual inquiries.

At the non-transitory computer-readable storage medium of the fourth aspect, the set of operations may further comprise: comparing the respective comparison scores to a threshold score; and when none of the respective comparison scores meet the threshold score, providing the textual inquiry to the LLM engine comprises: providing the textual inquiry to the LLM engine without any of the respective related textual responses.

At the non-transitory computer-readable storage medium, the set of operations may further comprise: comparing the respective comparison scores to a threshold score; and when two or more of the respective comparison scores meet the threshold score, providing the textual inquiry to the LLM engine comprises: providing the textual inquiry to the LLM engine with the respective related textual responses associated with the two or more of the respective comparison scores meet the threshold score.

At the non-transitory computer-readable storage medium, the set of operations may further comprise: comparing the respective comparison scores to a threshold score; and when two or more respective comparison scores meet the threshold score, providing the textual inquiry to the LLM engine comprises: providing the textual inquiry to the LLM engine with the respective related textual responses associated with the two or more respective comparison scores meet the threshold score such that the LLM response comprises an LLM generated combination of the respective related textual responses associated with the two or more respective comparison scores meet the threshold score.

At the non-transitory computer-readable storage medium of the fourth aspect, the set of operations may further comprise: comparing a pair of the textual inquiry and the LLM response to pairs of the previously stored textual inquiries and the respective related textual responses to determine respective pair difference comparison scores between the pair and the pairs, and providing, to the programmatic search engine, the textual inquiry and the LLM response for storage may be further based on one or more of the respective pair difference comparison scores. At the non-transitory computer-readable storage medium of the fourth aspect providing, to the programmatic search engine, the textual inquiry and the LLM response for storage may occur when a smallest respective pair difference comparison score is less than a given pair storage threshold score. At the non-transitory computer-readable storage medium of the fourth aspect providing, to the programmatic search engine, the textual inquiry and the LLM response for storage may occur when an average of the respective pair difference comparison scores is less than a given pair storage threshold score. At the non-transitory computer-readable storage medium of the fourth aspect providing, to the programmatic search engine, the textual inquiry and the LLM response for storage may occur when a given number of the respective pair difference comparison scores is less than a given pair storage threshold score.

At the non-transitory computer-readable storage medium of the fourth aspect, the set of operations may further comprise, prior to providing the textual inquiry and the LLM response for storage: collecting, for a given time period, one or more associated textual inquiries and respective LLM responses, including the textual inquiry and the LLM response, that meet the storage criteria; determining one or more of: a number of the one or more associated textual inquiries; a variance between the respective LLM responses; and a total comparison score representing a comparison between the one or more associated textual inquiries and the respective LLM responses, and the associated stored textual inquiries and the respective related textual responses; comparing one or more of the number, the variance and the total comparison score to respective thresholds; and when the comparing meets a further storage criteria, providing, to the programmatic search engine, the one or more associated textual inquiries and the respective LLM responses, including the textual inquiry and the LLM response, for storage.

At the non-transitory computer-readable storage medium of the fourth aspect, the set of operations may further comprise, after the textual inquiry and the LLM response are stored: again providing the textual inquiry to the LLM engine, and receiving an updated LLM response; comparing the LLM response and the updated LLM response to determine a respective difference comparison score therebetween; when the respective difference comparison score is above a first threshold: marking the LLM response as deteriorated; and thereafter periodically generating the updated LLM response and again determining the respective difference comparison score therebetween; or when the respective difference comparison score is above a second threshold, larger than the first threshold, controlling the programmatic search engine to delete at least the LLM response.

At the non-transitory computer-readable storage medium of the fourth aspect, a memory, accessible by the programmatic search engine, that stores the previously stored textual inquiries in association with respective related textual responses may initially empty, and the set of operations may further comprise: populating the memory with one or more textual inquiries from one or more client devices and associated LLM responses from the LLM engine.

### BRIEF DESCRIPTIONS OF THE DRAWINGS

For a better understanding of the various examples described herein and to show more clearly how they may be carried into effect, reference will now be made, by way of example only, to the accompanying drawings in which:

FIG. 1 depicts a system for efficient operation of a large language model engine in conjunction with a programmatic search engine, according to non-limiting examples.

FIG. 2 depicts a computing device for efficient operation of a large language model engine in conjunction with a programmatic search engine, according to non-limiting examples.

FIG. 3 depicts a method for efficient operation of a large language model engine in conjunction with a programmatic search engine, according to non-limiting examples.

FIG. 4 depicts the system of FIG. 1 implementing aspects of method for efficient operation of a large language model engine in conjunction with a programmatic search engine, according to non-limiting examples

FIG. 5 depicts the system of FIG. 1 implementing further aspects of method for efficient operation of a large language model engine in conjunction with a programmatic search engine, according to non-limiting examples

FIG. 6 depicts the system of FIG. 1 implementing further aspects of method for efficient operation of a large language model engine in conjunction with a programmatic search engine, according to non-limiting examples

FIG. 7 depicts the system of FIG. 1 implementing further aspects of method for efficient operation of a large language model engine in conjunction with a programmatic search engine, according to non-limiting examples

FIG. 8 depicts the system of FIG. 1 implementing further aspects of method for efficient operation of a large language model engine in conjunction with a programmatic search engine, according to non-limiting examples

FIG. 9 depicts the system of FIG. 1 implementing further aspects of method for efficient operation of a large language model engine in conjunction with a programmatic search engine, according to non-limiting examples

FIG. 10 depicts the system of FIG. 1 implementing further aspects of method for efficient operation of a large language model engine in conjunction with a programmatic search engine, according to non-limiting examples.

FIG. 11 depicts the system of FIG. 1 implementing further aspects of method for efficient operation of a large language model engine in conjunction with a programmatic search engine, according to non-limiting examples.

### DETAILED DESCRIPTION

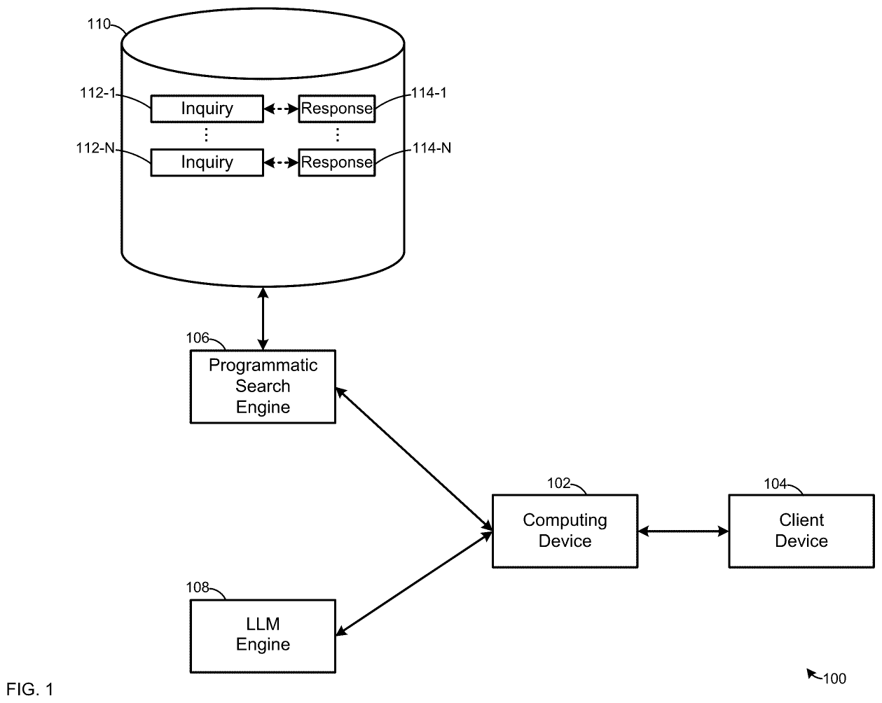

FIG. 1 depicts a system 100 for efficient operation of a large language model engine in conjunction with a programmatic search engine. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

The system 100 comprises a computing device 102, a client device 104, a programmatic search engine 106 and a large language model (LLM) engine 108.

As depicted, the system 100 further comprises a memory 110 communicatively coupled with the programmatic search engine 106. The memory 110 may, as depicted, be provided in the form a database. The memory 110 may be separate from the programmatic search engine 106 (as depicted) and/or at least partially integrated into the programmatic search engine 106.

The computing device 102 may comprise any suitable combination of one or more servers, one or more cloud computing devices, one or more personal computers, one or more laptops, and the like.

The client device 104 may comprise any suitable client device including, but not limited to a mobile device, a cell phone, a mobile phone, a tablet, a laptop, a personal computer, and the like.

As used herein, the term “engine” refers to hardware (e.g., a processor, such as a central processing unit (CPU), graphics processing unit (GPU), an integrated circuit or other circuitry) or a combination of hardware and software (e.g., programming such as machine- or processor-executable instructions, commands, or code such as firmware, a device driver, programming, object code, etc. as stored on hardware). Hardware includes a hardware element with no software elements such as an application specific integrated circuit (ASIC), a Field Programmable Gate Array (FPGA), a PAL (programmable array logic), a PLA (programmable logic array), a PLD (programmable logic device), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or implemented or interpreted by a processor), or hardware and software hosted at hardware.

The engines 106, 108 may be implemented by any suitable combination of one or more servers, one or more cloud computing devices, one or more personal computers, one or more laptops, and the like.

Furthermore, while the engines 106, 108 are depicted as separate components, the engines 106, 108 may be implemented at a same server and/or cloud computing device and/or personal computer and/or laptop, and/or one or more related servers, one or more related cloud computing devices, one or more related personal computers, one or more related laptops, and the like.

Similarly, the computing device 102 may be combined with one or more of the engines 106, 108 and/or the computing device 102 may implement, or at least partially implement, one or more of the engines 106, 108.

The computing device 102 is communicatively coupled to the engines 106, 108 and may, as depicted, be at least temporarily communicatively coupled to the client device 104.

For example, the client device 104 may initiate a search session with the computing device 102, for example, via a web browser, an application implemented at the client device 104, and the like, and the computing device 102 may host a browsing session and/or an application session with the client device 104 in which textual inquiries are received at the computing device 102 from the client device 104. The computing device 102 may return responses for the textual inquiries to the client device 104 as described herein. Indeed, the responses may be provided in the form of a graphic user interface (GUI) provided at a display screen of the client device 104 at which textual inquiries are received, and at which textual responses from the computing device 102 are provided.

In particular, the search session may be provided in the form a chat session in which the client device 104 is interacting with a chatbot as implemented by the computing device 102 in conjunction with the programmatic search engine 106 and the LLM engine 108 as described herein.

In the absence of the LLM engine 108, the computing device 102 may provide the textual inquiry to the programmatic search engine 106, which may comprise a chatbot engine. The programmatic search engine 106 may search the memory 110 for keywords in textual inquiries (e.g., using database lookup techniques, and the like) from the client device 104, for example to find textual inquiries stored at the memory 110 in association with respective answers.

For example, as depicted, the memory 110 stores textual inquiries 112-1 . . . 112-N (e.g., labelled “Inquiries” in FIG. 1) in association with respective textual responses 114-1 . . . 114-N (e.g., labelled “Responses” in FIG. 1). The textual inquiries 112-1 . . . 112-N are hereafter interchangeably referred to, collectively, as the inquiries 112 and, generically, as an inquiry 112. This convention will be used throughout the present specification. For example, the respective textual responses 114-1 . . . 114-N are hereafter interchangeably referred to as the textual responses 114 and/or the responses 114, or as a textual response 114 and/or a textual response 114.

Furthermore, the association between textual inquiries 112 and textual responses 114 is shown in FIG. 1, and throughout the present specification, via dashed double-ended arrows therebetween.

It is further understood that the inquiries 112 may be stored in the form of keywords extracted from previous inquiries and/or keywords prepopulated at the memory 110. Similarly, the inquiries 112 and respective textual responses 114 may initially be manually generated and prepopulated at the memory 110 and/or the inquiries 112 and respective textual responses 114 may be populated at the memory 110 in any suitable manner. The textual responses 114 may comprise natural language textual responses.

Furthermore, a number “N” of the inquiries 112 and respective textual responses 114 may be any suitable number, that may increase (or decrease) over time. In particular, the number “N” of the inquiries 112 and respective textual responses 114 may increase over time when updated using LLM responses received from the LLM engine 108, as described herein.

Regardless, it is understood that a textual inquiry received at the computing device 102 from the client device 104 may not correspond to any of the inquiries 112 and/or there may be only a low correspondence (e.g., as defined by a correspondence score, as described herein). As such, when the computing device 102 receives a textual inquiry from the client device 104, the computing device 102 may not be able to return a response 114 that answers the textual inquiry from the client device 104.

In particular, the programmatic search engine 106 is generally configured to return one or more textual responses 114 to the computing device 102, in response to receiving a textual inquiry from the computing device 102, the one or more responses 114 returned to the computing device 102 from the programmatic search engine 106 with respective comparison scores assigned to the one or more responses 114, based on the corresponding inquiries 112. Such respective comparison scores generally indicates a degree of a match between the textual inquiry received from the client device 104, and one or more textual inquiries 112 associated with the one or more responses 114 that are returned.

Put another way, the programmatic search engine 106 is generally configured to receive a textual inquiry from the computing device 102 (e.g., that was initially received at the computing device 102 from the client device 104), compare the textual inquiry to the textual inquiries 112 stored at the memory 110 to find matches therebetween, and assign a comparison score to the matches. In some examples, the programmatic search engine 106 may compare the textual inquiry received from the computing device 102 to all the textual inquiries 112 stored at the memory 110, and assign a comparison score to each respective response 114. In other examples, the programmatic search engine 106 may extract keywords from the textual inquiry received from the computing device 102 and perform a database lookup, and the like, of the textual inquiries 112 stored at the memory 110 and assign comparison scores only to those responses 114 that correspond, or at least partly correspond to textual inquiries 112 found in such a database lookup.

For example, a comparison score may be determined programmatically by the programmatic search engine 106 and may represent an exact and/or partial correspondence between keywords in the textual inquiry received from the computing device 102 and the inquiries 112, an exact and/or partial correspondence in an order of such keywords, and the like. In a particular example, such comparison scores may be on a scale of 0 to 100, where “O” represents no correspondence and/or a worst correspondence between keywords, and “100” represents a perfect correspondence and/or best correspondence between keywords. However, any suitable scale is within the scope of the present specification (e.g., including, but not limited to, “0” to 1, and the like).

Alternatively, or in addition, the comparison scores may represent a difference between a textual inquiry received from the client device 104 and textual inquiries 112 stored at the memory 110, with “0” representing no difference and/or a minimum difference between keywords, and “100” representing a worst difference and/or a maximum difference between keywords. For example, the textual inquiry from the client device 104 and the textual inquiries 112 stored at the memory 110 may be converted to vectors, and differences between such vectors may be determined in this scheme.

However, any suitable scheme for the comparison scores is within the scope of the present specification, with respective threshold scores described herein adapted accordingly.

However, hereafter, the example of a comparison score of “0” representing no correspondence and/or a worst correspondence between keywords, and “100” represents a perfect correspondence and/or best correspondence between keywords is used.

As such it furthermore understood that the programmatic search engine 106 operates programmatically, for example based on database lookup searches of the memory 110, and the like, without the use of machine learning and/or artificial intelligence, and the like, such that response times of the programmatic search engine 106 may be generally lower than response times of the LLM engine 108. The comparison scores (e.g., using vectors, and the like) are similarly determined programmatically and without the use of machine learning and/or artificial intelligence.

Regardless of how the respective responses 114 and comparison scores are programmatically determined, the programmatic search engine 106 returns one or more respective responses 114 to the computing device 102 with respective comparison scores. When the programmatic search engine 106 compares the textual inquiry received from the computing device 102 to all the textual inquiries 112 stored at the memory 110, the programmatic search engine 106 may return only a given number of the respective responses 114 having the highest comparison scores, such as the top 3, the top 5, or the top responses 114 having the highest comparison scores, amongst other possibilities.

Regardless, the computing device 102 is understood to receive one or more associated responses 114 that may “answer” the textual inquiry received from the client device 104 and/or, put another way, the one or more associated responses 114 may comprise proposed answers to the textual inquiry received from the client device 104. As such, the one or more associated responses 114 may be referred to hereafter as one or more respective related textual responses 114 as each respective related textual responses 114 may be a proposed answer to the textual inquiry received from the client device 104.

The computing device 102 may determine whether, or not, to provide a given textual response 114 to the client device 104 as an answer to the textual inquiry received from the client device 104 based on the comparison scores. The comparison scores may further be used to determine whether, or not, to use the LLM engine 108 to generate an LLM response to be provided to the client device 104 as an answer to the textual inquiry received from the client device 104 (e.g., rather than a textual response 114 received from the programmatic search engine 106) as described herein.

For example, the computing device 102 may compare the respective comparison scores with a threshold score, such as (using the aforementioned sale of 0 to 100), 70, 80, 90, or any other suitable threshold score.

When only one the respective comparison scores are above the threshold score, the computing device 102 provides the respective textual response 114 to the client device 104, for example as an answer provided in response to receiving the textual inquiry from the client device 104.

However, when none of the associated responses 114 are associated with respective comparison scores above the threshold score (e.g., all the respective comparison scores are below the threshold score), the computing device 102 may provide the textual inquiry, received from the client device 104, to the LLM engine 108, and the LLM engine 108 may return an LLM response to the textual inquiry to the computing device 102. The computing device 102 may receive the LLM response and provide the LLM response to the client device 104, for example as an answer to the textual inquiry received from the client device 104. In this example, the computing device 102 provides the textual inquiry, received from the client device 104, to the LLM engine 108 without any of the respective related textual responses 114 as all were associated with respective comparison scores below the threshold score.

However, when two or more of the respective related textual responses 114 are associated with respective comparison scores above the threshold score, the computing device 102 may provide the textual inquiry, from the client device 104, to the LLM engine 108 along with the two or more respective related textual responses 114 from the programmatic search engine 106 that are associated with respective comparison scores above the threshold score. The LLM engine 108 may return an LLM response, and in these examples the LLM response may comprise an LLM generated combination of the respective related textual responses 114 associated with the two or more respective comparison scores that meet the threshold score. The LLM response may be provided to the client device 104 by the computing device 102, for example as an answer to the textual inquiry received from the client device 104.

Furthermore, in some examples, any LLM response provided to the client device 104 by the computing device 102 may be provided with a request for feedback regarding the LLM response. Such a request for feedback may be in form of one or more electronic buttons provided in the GUI at the client device 104, such as “YES” or “NO” buttons (e.g., and/or corresponding “thumbs up” or “thumbs down” buttons), and the like, which, when actuated, respectively indicate whether or not the provided LLM response is accurate and/or is an approved response to the textual inquiry received from the client device 104.

In particular, when one of such buttons is actuated at the client device 104, the client device 104 may provide associated feedback on the LLM response that is indicative of which of such buttons have been actuated. For example, feedback provided in response to actuation of a “YES” button may indicate that the LLM response is approved. However, feedback provided in response to actuation of a “NO” button may indicate that the LLM response is not approved.

However, such feedback may be in any suitable format. For example, rather than actuation of an electronic button, the computing device 102 may receive, from the client device 104, and indication of whether or not the LLM response is approved, for example in the form of text, such as “Thank you, that is a good answer, really helps” or “That doesn't answer my question”, and the like. In these examples, the phrase “Thank you, that is a good answer, really helps” may indicate that the LLM response is approved and, conversely, the response “That doesn't answer my question” may indicate that the LLM response is not approved. The computing device 102, in these example, may be configured to analyze such phrases for keywords (e.g., such as “good answer” or “doesn't answer”) to determine whether the LLM response is approved or not, and/or the computing device 102 may, itself, implement a machine learning algorithm to determine whether or not an LLM response is approved.

The computing device 102 may generally compare the feedback received from the client device 104 to a storage criteria that may generally conditions under which an LLM response is approved for storage at the memory 110. For example, such storage criteria may comprise “when the feedback is “YES”, an LLM response is approved” and/or such storage criteria may comprise “when the feedback corresponds to text indicating approval of the LLM response, an LLM response is approved”, and the like.

When the feedback meets the storage criteria, the computing device 102 may provide the programmatic search engine 106 with the textual inquiry, originally received from the client device 104, and the LLM response provided to the client device 104 as an answer to the textual inquiry for storage at the memory 110, for example as a respective new pair of a textual inquiry 112 and a corresponding textual response 114, for use in generating responses to later textual inquiries from client devices.

As such, it is understood that the textual inquiry is now stored at the memory 110 as a new textual inquiry 112 in association with a textual response 114 comprising the LLM response.

While generation of a given LLM response by the LLM engine 108 may have higher processing resource overhead as compared to responses provided by the programmatic search engine 106, a later textual inquiry may be received at the computing device 102 from a client device (which may be the same or different from the client device 104) that is similar to a previous textual inquiry 112 now stored at the memory 110 in association with a textual response 114 comprising the given LLM response. It is understood that such a previous textual inquiry 112 comprises the textual inquiry received from the client device 104 that resulted in the given LLM response.

In this example, it is understood that the later textual inquiry may be same as, or similar to the previous textual inquiry 112 and hence a determined comparison score is understood to be above, and/or well above, the threshold score.

As such, when the later textual inquiry is received, the previously generated LLM response stored at the memory 110 as a textual response 114 may be provided to the client device from which the later textual inquiry was received, rather than again query the LLM engine 108 for an LLM response.

In this manner, queries to the LLM engine 108 may be reduced over time, for example as the memory 110 is populated with textual inquiries 112 received from client devices in association with respective textual responses 114 comprising LLM responses generated by the LLM engine 108. As queries to the LLM engine 108 are reduced over time, operation of the system 100 and/or the computing device 102 becomes more efficient and/or faster over time, as use of processing resources of the LLM engine 108 are reduced over time, and/or communications with the LLM engine 108 are reduced over time.

There are at least two scenarios that may occur when the memory 110 is populated with textual inquiries 112 received from client devices in association with respective textual responses 114 comprising LLM responses generated by the LLM engine 108.

A first scenario may correspond to the previously described example where the computing device 102 provides only a textual inquiry received from the client device 104 to the LLM engine 108 as no comparison scores are above the threshold score. In this scenario a given LLM response is stored at the memory 110 as a textual response 114 in association with a textual inquiry 112 as received from the client device 104. In this first scenario, a later textual inquiry may be received from a same or different client device that is similar and/or the same as the textual inquiry 112 that was previously received from the client device 104. As such, a comparison score between the later textual inquiry and the textual inquiry 112 that was previously received from the client device 104 may be the only comparison score above the threshold score and the associated textual response 114 that comprises the previously generated LLM response may be provided as an answer in response to the client device from which the later textual inquiry was received.

A second scenario may correspond to the previously described example where the computing device 102 provides two or more related textual responses 114 along with the textual inquiry from the client device 104, to the LLM engine 108, as two are more respective comparison scores are above the threshold score. In these examples, the resulting LLM response is stored at the memory 110 as a textual response 114 in association with the textual inquiry 112 received from the client device 104. As such, when a later textual inquiry is received from a client device that is similar to the original textual inquiry, more than one related textual response 114 may be associated with comparison scores above the threshold score (e.g., as the later textual inquiry may be similar to both the textual inquiry 112 received from the client device 104 and the two or more related textual responses 114 associated with comparison scores above the threshold score). However, in this example, the related textual response 114 that comprises the LLM response may have a comparison score that is higher than the comparison scores of the other related textual responses 114. In this example, the computing device 102 may compare the comparison scores associated with all the related textual responses 114 and determine that the related textual response 114 that comprises the LLM score has a higher associated comparison score than those associated with the other related textual responses 114. In these instances, the related textual response 114 that comprises the LLM response may be used as the textual response 114 provided to the client device as the related textual response 114 that comprises the LLM response is associated with the highest comparison score.

In such examples, a thresholding scheme may be used to distinguish between the related textual response 114 that comprises the LLM response and other the other related textual responses 114.

In particular, as the later textual inquiry is understood to be the same or similar to the textual inquiry 112 associated with the related textual response 114 that comprises the LLM response, it is understood that the associated comparison score may be higher or much higher than comparison scores associated with the other related textual responses 114, as determined using a threshold difference score. In particular, differences between the comparison scores associated with the related textual responses 114 may be determined and the related textual response 114 having the highest comparison score may be selected as the related textual response 114 to be provided to the client device from which the later textual inquiry was received, however only when a difference between the highest comparison score and a next lowest comparison score and/or an average of the other comparison scores is above a threshold difference comparison score. Using a scale of “0” to “100” for the comparison scores, such a threshold difference comparison score may comprise 5, 10, 15, amongst other possibilities. Furthermore, such a scheme may be implemented using vector techniques, for example to determine differences between vector that represent the related textual responses 114.

Indeed, this scheme may also be used when two or more related textual responses 114 are received from the programmatic search engine 106 under any suitable conditions.

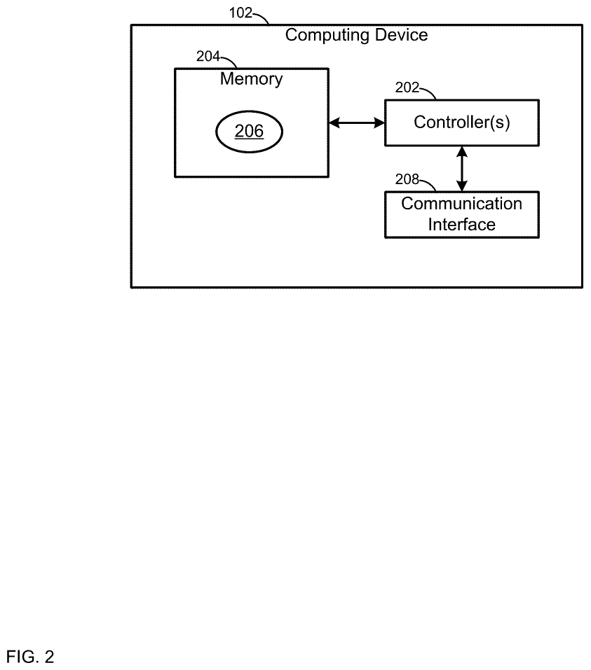

Turning to FIG. 2, before discussing the functionality of the system 100 in greater detail, certain components of the computing device 102 will be described. While depicted as one device, the computing device 102 may comprise one or more computing devices and/or one or more cloud computing devices that may be geographically distributed.

As shown in FIG. 2, the computing device 102 includes at least one controller 202, such as a central processing unit (CPU) or the like. The controller 202 is interconnected with a memory 204 storing an application 206, the memory 204 implemented as a suitable non-transitory computer-readable medium (e.g., a suitable combination of non-volatile and volatile memory subsystems including any one or more of Random Access Memory (RAM), read only memory (ROM), Electrically Erasable Programmable Read Only Memory (EEPROM), flash memory, magnetic computer storage, and the like). The controller 202 and the memory 204 are generally comprised of one or more integrated circuits (ICs).

The controller 202 is also interconnected with a communication interface 208, which enables the computing device 102 to communicate with the other components of the system 100, though it is understood such communication may occur locally when components of the system 100 are combined. The communication interface 208 therefore may include any necessary components (e.g., network interface controllers (NICs), radio units, and the like) to communicate with components of the system 100. The specific components of the communication interface 208 may be selected based on upon a nature of one or more networks that the components of the system 100 use to communicate, and/or local communication between components of the system 100, and the like. The computing device 102 may also include input and output devices connected to the controller 202, such as keyboards, pointing devices, display screens, and the like (not shown).

The components of the computing device 102 mentioned above may be deployed in a single enclosure, or in a distributed format. In some examples, therefore, the computing device 102 includes a plurality of processors, either sharing the memory 204 and communication interface 208, or each having distinct associated memories and communication interfaces. As such, it is understood that the memory 204, and/or a portion of the memory 204, may be internal (e.g., as depicted) or external to the computing device 102; regardless, the controller 202 is understood to have access to the memory 204.

Furthermore the application 206 may comprise computer-readable programming instructions, executable by the controller 202.

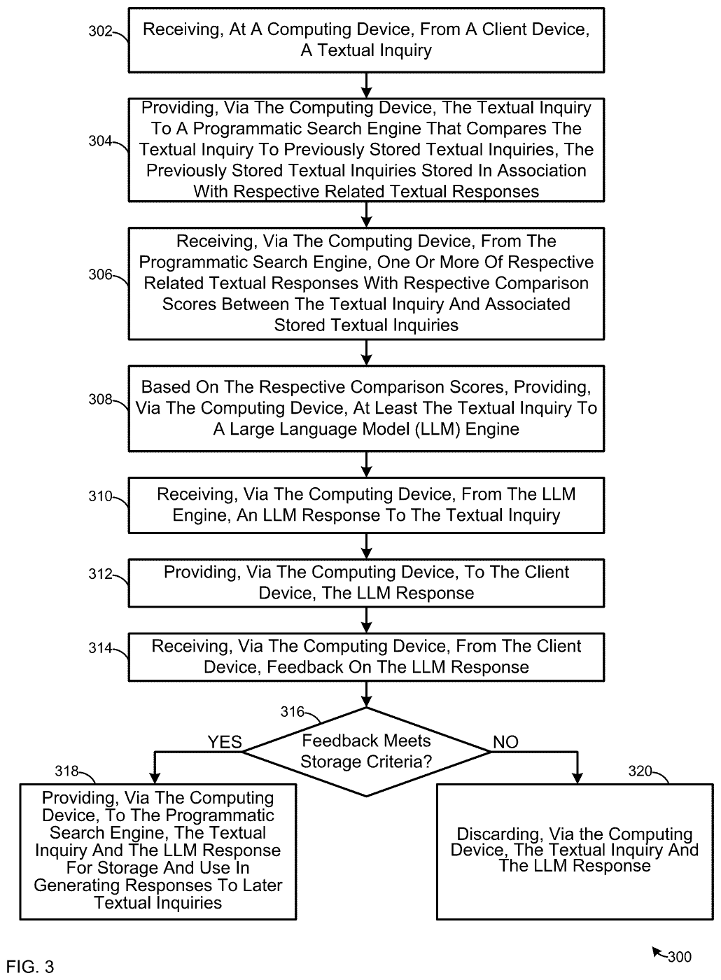

As will be understood by those skilled in the art, the controller 202 executes the instructions of the application 206 in order to perform a set of operations defined by the instructions contained therein including, but not limited to, the blocks of a method described with respect to FIG. 3. In the description below, the controller 202, and more generally the computing device 102, are understood to be configured to perform those actions. It will be understood that they are so configured via the execution (by the controller 202) of the instructions of the application stored in the memory 204. Put another way, the computing device 102 may comprise a computer-readable storage medium (e.g., a non-transitory computer-readable storage medium, such as the memory 204) having stored thereon program instructions that, when executed by the controller 202, causes the controller 202 to perform a set of operations comprising the blocks of the method described with respect to FIG. 3.

While structure of the client device 104, and the engines 106, 108 are not described in detail, the client device 104 and the engines 106, 108 are understood to have a similar structure as the computing device 102, but adapted for respective functionality of the client device 104, and the engines 106, 108.

For example, the client device 104 may comprise any suitable combination of input and output devices such as a display screen, a touch screen, a keyboard, a pointing device, and the like.

Furthermore, the programmatic search engine 106 is understood to include one or more respective applications for programmatically implementing, via one or more respective controllers, and the like, functionality described herein, without the use of machine learning algorithms.

In contrast, the LLM engine 108 is understood to include one or more respective applications for implementing, via one or more respective controllers, and the like, functionality described herein, and in particular any suitable LLM application.

Attention is now directed to FIG. 3 which depicts a flowchart representative of a method 300 a method for efficient operation of a large language model engine in conjunction with a programmatic search engine. The operations of the method 300 of FIG. 3 correspond to machine readable instructions that are executed by the computing device 102, and specifically the controller 202 of the computing device 102. In the illustrated example, the instructions represented by the blocks of FIG. 3 are stored at the memory 204 for example, as the application 206. The method 300 of FIG. 3 is one way in which the system 100 and/or the computing device 102 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of, as well.

At a block 302, the controller 202, and/or the computing device 102, receives, from the client device 104, a textual inquiry.

At a block 304, the controller 202, and/or the computing device 102, provides the textual inquiry to the programmatic search engine 106 that compares the textual inquiry to previously stored textual inquiries 112, the previously stored textual inquiries 112 stored in association with respective related textual responses 114.

At a block 306, the controller 202, and/or the computing device 102, receives, from the programmatic search engine 106, one or more of respective related textual responses 114 with respective comparison scores between the textual inquiry and associated stored textual inquiries 112.

At a block 308, the controller 202, and/or the computing device 102, based on the respective comparison scores, provides at least the textual inquiry to the large language model LLM engine 108.

For example, the method 300, and in particular the block 308, may further comprise the controller 202 and/or the computing device 102: comparing the respective comparison scores to a threshold score; and when none of the respective comparison scores meet the threshold score, providing the textual inquiry to the LLM engine 108 may comprise: providing the textual inquiry to the LLM engine 108 without any of the respective related textual responses.

Alternatively, in further examples, the method 300, and in particular the block 308, may further comprise the controller 202 and/or the computing device 102: comparing the respective comparison scores to a threshold score; and when two or more of the respective comparison scores meet the threshold score, providing the textual inquiry to the LLM engine 108 may comprise: providing the textual inquiry to the LLM engine 108 with the respective related textual responses 114 associated with the two or more of the respective comparison scores that meet the threshold score.

At a block 310, the controller 202, and/or the computing device 102, receives, from the LLM engine 108, an LLM response to the textual inquiry.

For example, the method 300, and in particular the block 308 and the block 310 may further comprise the controller 202 and/or the computing device 102: comparing the respective comparison scores to a threshold score; and when two or more respective comparison scores meet the threshold score, providing the textual inquiry to the LLM engine 108 at the block 308 may comprise: providing the textual inquiry to the LLM engine 108 with the respective related textual responses 114 associated with the two or more respective comparison scores meet the threshold score, such that the LLM response received at the block 310 comprises an LLM generated combination of the respective related textual responses 114 associated with the two or more respective comparison scores that meet the threshold score. Such an LLM generated combination of the respective related textual responses may be more accurate than the respective related textual responses each taken alone.

At a block 312, the controller 202, and/or the computing device 102, provides, to the client device 104, the LLM response.

At a block 314, the controller 202, and/or the computing device 102, receives, from the client device 104, feedback on the LLM response.

At a block 316, the controller 202, and/or the computing device 102 determines whether the feedback meets storage criteria (e.g., as previously described). When the feedback meets the storage criteria (e.g., a YES decision at the block 316), at a block 318, the controller 202, and/or the computing device 102, provides, to the programmatic search engine 106, the textual inquiry and the LLM response for storage (e.g., at the memory 110) and use in generating responses to later textual inquiries.

However, when the feedback does not meet the storage criteria (e.g., a NO decision at the block 316), at a block 320, the controller 202, and/or the computing device 102, discards the textual inquiry and the LLM response.

The method 300 may include other features.

For example, the feedback may be used to better train the LLM engine 108. For example, the input to the LLM engine 108, and the LLM response from the LLM engine 108, along with a score representing the feedback received from the client device 104 (e.g., “1” for positive feedback and “0” for negative feedback” may be provided to the LLM engine 108 operated in a machine learning training mode.

Furthermore, at the block 306, when two or more of respective related textual responses 114, with respective comparison scores are received at the computing device 102, a highest respective comparison score may be compared to a next highest comparison score and/or an average of the other comparison scores and, when a difference between the highest respective comparison score and a next highest comparison score and/or an average of the other comparison scores is above a threshold difference comparison score, the controller 202 and/or the computing device 102 may provide the respective related textual response 114 having the highest comparison score to the client device 104 rather than querying the LLM engine 108. Such an example may occur when the respective related textual response 114 having the highest comparison score comprises a previously generated LLM response generated in response to a previously received textual inquiry that is the same or similar as the textual inquiry received from the client device 104.

In yet further examples, the method 300 may further comprise the controller 202 and/or the computing device 102: comparing a pair of the textual inquiry and the LLM response to pairs of the previously stored (e.g., at the memory 110) textual inquiries 112 and the respective related textual responses 114 to determine respective pair difference comparison scores between the pair and the pairs. In these examples, at the block 318, providing to the programmatic search engine 106 the textual inquiry and the LLM response for storage may be further based on one or more of the respective pair difference comparison scores.

In particular, in contrast to the previously described comparison scores, that are based on a comparison between a textual inquiry received from a client device and textual inquiries 112 stored at the memory 110, the respective pair difference comparison scores may be based on a comparison between a pair of a textual inquiry received from a client device, an associated LLM response, and pairs of the textual inquiries 112 and the respective related textual responses 114 stored at the memory 110.

Indeed, the respective pair difference comparison scores may be used to determine a degree to which a pair of a textual inquiry and an LLM response differs from existing pairs of textual inquiries 112 and respective related textual responses 114.

In particular, while not depicted at FIG. 3, the block 316 may further comprise comparing a pair of the textual inquiry and the LLM response to pairs of the previously stored (e.g., at the memory 110) textual inquiries 112 and the respective related textual responses 114 to determine respective pair difference comparison scores between the pair and the pairs and a “YES” decision may occur at the block 316 when the feedback meets the storage criteria and or one or more respective pair difference comparison scores meet a given pair storage threshold score as is next described.

The respective pair difference comparison scores may be determined in a manner similar to the previously described comparison scores, for example by respectively comparing respective keywords in a pair of a textual inquiry and a LLM response, to keywords of respective textual inquiries 112 and respective related textual responses 114. However, in contrast to the previously described comparison scores, a pair difference comparison score may be lower when a difference between a pair of a textual inquiry and an LLM response, and a pair of textual inquiry 112 and a respective related textual responses 114 is small, and higher when a difference between a pair of a textual inquiry and a LLM response, and a pair of textual inquiry 112 and a respective related textual responses 114 is high. Nonetheless any suitable scheme may be used to compare a pair of a textual inquiry and a LLM response to pairs of associated textual inquiries 112 and responses 114, with pair storage threshold scores (described below) adapted accordingly.

However, in this example, the lower a respective pair difference comparison score, the higher a match between a pair of a textual inquiry and a LLM response, and a pair of a textual inquiry 112 and a respective textual response 114, and vice versa. Again a pair difference comparison score may be on a scale of 0 to 100, or any other suitable scale (e.g., “0” to 1, and the like).

In some examples, at the block 318, providing to the programmatic search engine 106, the textual inquiry and the LLM response for storage may occur when a smallest respective pair difference comparison score is less than a given pair storage threshold score. For example, the given pair storage threshold score may be selected such that a given LLM response is not significantly different from existing textual responses 114. Put another way, the given pair storage threshold score may comprise, using a scale of 0 to 100, a difference of 5, 10, 15, amongst other possibilities between.

In other examples, at the block 318, providing to the programmatic search engine 106, the textual inquiry and the LLM response for storage may occur when an average of the respective pair difference comparison scores is less than the given pair storage threshold score.

In yet further examples providing, at the block 318, to the programmatic search engine 106, the textual inquiry and the LLM response for storage may occur when a given number of the respective pair difference comparison scores is less than the given pair storage threshold score.

In this manner, the computing device 102 may ensure that differences in an LLM response and existing textual responses 114 do not vary significantly.

It is understood that the pair difference comparison scores and the given pair storage threshold score are different from the respective comparison scores and the threshold score of the block 308 and the block 310. In particular, the respective comparison scores and the threshold score of the block 308 and the block 310 may be used to determine whether or not to provide an LLM response to the client device 104, while the pair difference comparison scores and the given pair storage threshold score may be used (e.g., in addition to the feedback) to determine whether or not to store an LLM response at the memory 110.

In further examples, the method 300 may further comprise the controller 202 and/or the computing device 102, prior to providing, at the block 318, the textual inquiry and the LLM response for storage: collecting, for a given time period, one or more associated textual inquiries and respective LLM responses, including the textual inquiry and the LLM response (e.g., respectively of the blocks 302, 310), that meet the storage criteria (e.g., of the block 316); determining one or more of: a number of the one or more associated textual inquiries; a variance between the respective LLM responses; and a total comparison score representing a comparison between the one or more associated textual inquiries and the respective LLM responses, and associated stored textual inquiries 112 and the respective related textual responses 114; comparing one or more of the number, the variance and the total comparison score to respective thresholds; and when the comparing meets a further storage criteria, providing, to the programmatic search engine 106, the one or more associated textual inquiries and the respective LLM responses, including the textual inquiry and the LLM response, for storage.

For example, over a given time period, such as one day, two days, one week, amongst other possibilities, the computing device 102 may collect pairs of textual inquiries, received from one or more client devices, and LLM responses generated as described herein. Such pairs of textual inquiries and LLM responses are understood to be related to each other, for example as determined using comparison and/or thresholding techniques as described herein. Indeed, the computing device 102 may collect different pairs of textual inquiries and LLM responses that pertain to different topics, and the like, and techniques described herein may be applied to such different pairs of textual inquiries and LLM responses. Classification of the pairs of pairs of textual inquiries and LLM responses may be based on the textual inquiries received from client devices.

For a given set of pairs of related textual inquiries and LLM responses, collected over the given time period, the computing device 102 may determine a number thereof (e.g., a number of pairs of related textual inquiries and LLM responses), which may represent a general interest in a topic thereof over the given time period (e.g., the higher the number, the higher the interest).

The computing device 102 may further determine a variance between the given set of pairs, with a smaller variance indicating a smaller difference therebetween, and a higher variance indicating a larger difference therebetween. The variance may be on a scale of 0 to 100, or any suitable scale. Hence, the variance may represent how the LLM engine 108 answers to textual inquiries vary over the given time period, with a smaller variance representing a higher consistency in such answers and a larger variance representing a lower consistency in such answers. Indeed, a variance being larger may indicate that the LLM engine 108 has been poorly trained to respond to inquiries on the topic and/or that training of the LLM engine 108 with respect to the topic is changing rapidly.

The computing device 102 may further determine a total comparison score representing a comparison between pairs of associated textual inquiries and the respective LLM responses, and associated stored textual inquiries 112 and the respective related textual responses 114. For example, the total comparison score may comprise an average of highest comparison scores between a given pair of a textual inquiry and a respective LLM response and associated stored textual inquiries 112 and the respective related textual responses 114, presuming that a high comparison score represents a higher match and lower comparison score represents a lower match. Alternatively, the total comparison score may be represented as an average of difference comparison scores, with a high comparison score represents a lower match and lower comparison score represents a higher match.

Regardless of the scheme of the total comparison score, such a total comparison score may represent how the one or more associated textual inquiries and the respective LLM responses differ from the existing stored textual inquiries 112 and the respective related textual responses 114.

Once the number, the variance and/or the total comparison score are determined, one or more of the number, the variance and the total comparison score may be compared, by the computing device 102, to respective thresholds, and whether or not the one or more associated textual inquiries and the respective LLM responses collected over the given time period are stored at the memory 110 may depend on further storage criteria.

For example, for the number, a respective threshold number may be 0, such that when the number of pairs of related textual inquiries and LLM responses is greater than 0, the pairs of pairs of related textual inquiries and LLM responses are all stored at the memory 110 when generated, and/or otherwise based on the method 300.

However, the respective threshold number may be set to greater than 0, such as 10, 20, 50, 100, amongst other possibilities, such that the pairs of related textual inquiries and LLM responses are only stored at the memory 110 when the number of pairs exceeds the respective threshold in the given time period. Alternatively, or in addition, rather than store all the pairs of related textual inquiries and LLM responses, when the number of the pairs of related textual inquiries and LLM responses exceed the respective threshold number in the given time period, the pairs of related textual inquiries and LLM responses may be provided to the LLM engine 108 (e.g., by the computing device 102), which may responsively generate one pair of a textual inquiries and a LLM response that is stored at the memory 110 as a new textual inquiry 112 and an associated textual response 114.

Similarly, for the variance, a respective threshold variance may be 5, 10, 15, amongst other possibilities (e.g., again based on a scale of 0 to 100), such that when the variance is less than the respective threshold variance, the pairs of related textual inquiries and LLM responses are all stored at the memory 110. Alternatively, or in addition, rather than store all the pairs of related textual inquiries and LLM responses, when the variance is less than the respective threshold variance in the given time period, the pairs of related textual inquiries and LLM responses may be provided to the LLM engine 108 (e.g., by the computing device 102), which may responsively generate one pair of a textual inquiries and a LLM response that is stored at the memory 110 as a new textual inquiry 112 and an associated textual response 114.

Similarly, for the total comparison score, and using difference comparison scores as an example, with a high comparison score represents a lower match and lower comparison score represents a higher match, the respective threshold total comparison score may be 5, 10, 15, amongst other possibilities (e.g., again based on a scale of 0 to 100), such that when the total comparison score is less than the respective threshold total comparison, the pairs of related textual inquiries and LLM responses are all stored at the memory 110. Alternatively, or in addition, rather than store all the pairs of related textual inquiries and LLM responses, when the total comparison score is less than the respective threshold total comparison in the given time period, the pairs of related textual inquiries and LLM responses may be provided to the LLM engine 108 (e.g., by the computing device 102), which may responsively generate one pair of a textual inquiries and a LLM response that is stored at the memory 110 as a new textual inquiry 112 and an associated textual response 114. Indeed, such a scheme ensures that the LLM responses stored at the memory 110 do not significantly vary from existing textual responses 114.

Indeed, any suitable combination of the number, the variance and the total comparison score may be used to determine whether or not to store one or more textual inquires and associated LLM responses at the memory 110. For example, in one scheme, further storage criteria may comprise textual inquiries and LLM responses collected over the given time period meeting two or more of the previously described respective thresholds.

In further examples, the method 300 may further comprise the controller 202 and/or the computing device 102, after the textual inquiry and the LLM response are stored (e.g., at the memory 110): again providing the textual inquiry to the LLM engine 108, and receiving an updated LLM response; comparing the LLM response and the updated LLM response to determine a respective difference comparison score therebetween; when the respective difference comparison score is above a first threshold: marking the LLM response as deteriorated; and thereafter periodically generating the updated LLM response and again determining the respective difference comparison score therebetween; and/or when the respective difference comparison score is above a second threshold, larger than the first threshold, controlling the programmatic search engine 106 to delete at least the LLM response.

In this example it is understood that the respective difference comparison score represents a difference between the LLM response and the updated LLM response, and the second threshold is understood to be larger than the first threshold. Hence, when the respective difference comparison score increases over time, it is understood that the original LLM response may no longer be valid, and the updated LLM response may be a better answer or response to an associated textual inquiry. Indeed, in some examples, when the respective difference comparison score is above the second threshold the controller 202 and/or the computing device 102 may control the programmatic search engine 106 to delete at least the LLM response from the memory 110, and add the textual inquiry and the updated LLM response to the memory 110 as a respective pair of a textual inquiry 112 and an associated textual response 114. In some examples, the updated LLM may replace a previously stored LLM response at the memory 110, such that the updated LLM is stored in association with the updated LLM response.

Again using a scale of 0 to 100, where “0” represents a lowest difference, and “100” represents a highest difference, the first threshold may be 10, 20 or 30, amongst other possibilities, and the second threshold may be 40, 50, or 60, amongst other possibilities, and/or the second threshold may be selected to be a value that is 10, 20 or 30 (e.g., amongst other possibilities) higher than the first threshold, and the like.

Furthermore, marking the LLM response as deteriorated when the respective difference comparison score is above a first threshold may cause the respective difference comparison score to be later periodically determined for the LLM response to track deterioration thereof, whereas LLM responses associated with difference comparison scores that are below the first threshold, may later have their respective difference comparison scores determined, but at a lower, or less frequent periodicity than the LLM response marked as deteriorated.

In yet further examples, initially, the memory 110 may not be populated with inquiries 112 and responses 114. While in some instances, the inquiries 112 and respective textual responses 114 may initially be manually generated and prepopulated at the memory 110 in other examples, such manual generation and prepopulation may not occur. Rather, when a textual inquiry is received at the computing device 102 from the client device 104 at the block 302, and provided to the programmatic search engine 106 at the block 304, the programmatic search engine 106 may return no respective related textual responses and/or a null set (e.g. as the memory 110 is empty). In these examples, in response to receiving no respective related textual responses and/or a null set, the computing device 102 provides the textual inquiry to the LLM engine 108 and receives an LLM response that is provided to the client device 104. The client device 104 may provide feedback on the LLM response (e.g. similar to the block 314) and when the feedback meets storage criteria (e.g. similar to a “YES” decision at the block 316), the computing device 102 provides the textual inquiry, originally received from the client device 104, and the LLM response to the programmatic search engine 106 for storage (e.g. similar to the block 318). However, when the feedback does not meet storage criteria (e.g. similar to a “NO” decision at the block 316), the computing device 102 discards the textual inquiry and the LLM response.

Similarly, in some instances, when a textual inquiry is received at the computing device 102 from the client device 104 at the block 302, and provided to the programmatic search engine 106 at the block 304, the programmatic search engine 106 may return one respective related textual response and a respective comparison score, which may not meet the threshold score. For example, the memory 110 may store only one inquiry 112 and a respective response 114 (e.g. that may correspond to one previous textual inquiry and one LLM response used to populate the memory 110 when the memory 110 is initially empty). In these examples, the computing device 102 provides the textual inquiry to the LLM engine 108 and receives an LLM response that is provided to the client device 104. The client device 104 may provide feedback on the LLM response (e.g. similar to the block 314) and when the feedback meets storage criteria (e.g. similar to a “YES” decision at the block 316), the computing device 102 provides the textual inquiry, originally received from the client device 104, and the LLM response to the programmatic search engine 106 for storage (e.g. similar to the block 318). However, when the feedback does not meet storage criteria (e.g. similar to a “NO” decision at the block 316), the computing device 102 discards the textual inquiry and the LLM response.

In this manner the inquiries 112 and responses 114 may be populated automatically at the memory 110 using textual inquiries from the client device 104 (and other client devices) and LLM responses. As the memory 110 stores increasing numbers of inquiries 112 and responses 114 (e.g. as more and more textual inquiries from the client device 104 (and other client devices) and LLM responses are used to populate the memory 110), use of the LLM engine 108 may generally decrease over time, and the system 100 may become more efficient.

Put another way, the memory 110, accessible by the programmatic search engine 106, that stores the previously stored textual inquiries 112 in association with respective related textual responses 114 may initially empty, and the method 300 may further comprise: populating the memory 110 with one or more textual inquiries from one or more client devices and associated LLM responses from the LLM engine 108. Indeed, in some instances, such population may occur with or without the aforementioned feedback.

In yet further examples, when a response 114 is received at the computing device 102, from the programmatic search engine 106 (e.g. similar to the block 306), the computing device 102 may provide both the response 114 and the associated textual inquiry from the client device 104 to the LLM engine 108, and the LLM engine 108 may provide an LLM response in return. Put another way, while previously examples were described in which the computing device 102 provided two or more respective related textual responses with a textual inquiry to the LLM engine 108, the present specification includes examples where the computing device 102 provides one or more respective related textual responses with a textual inquiry to the LLM engine 108 to receive an LLM response in return. For example, such a situation may occur when a comparison score for only one respective related textual responses meets the aforementioned threshold score but only within a particular range of the threshold score (e.g. such as the comparison score being only within 5% of the threshold score), and/or when only one respective related textual response is received from the programmatic search engine 106 with a comparison score that meets the threshold score (e.g. due to the memory 110 being only sparsely populated).

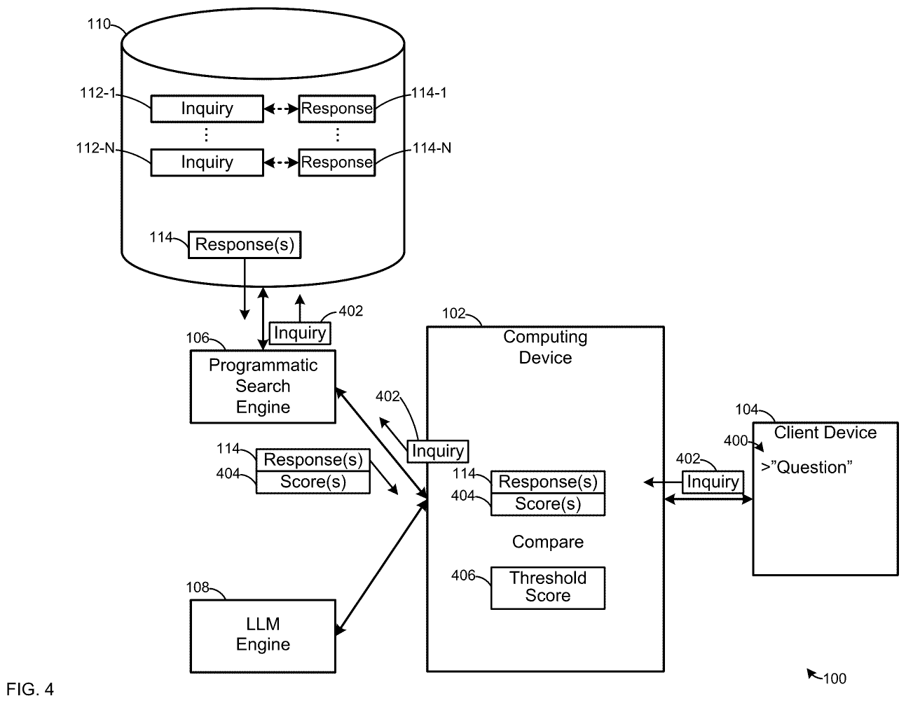

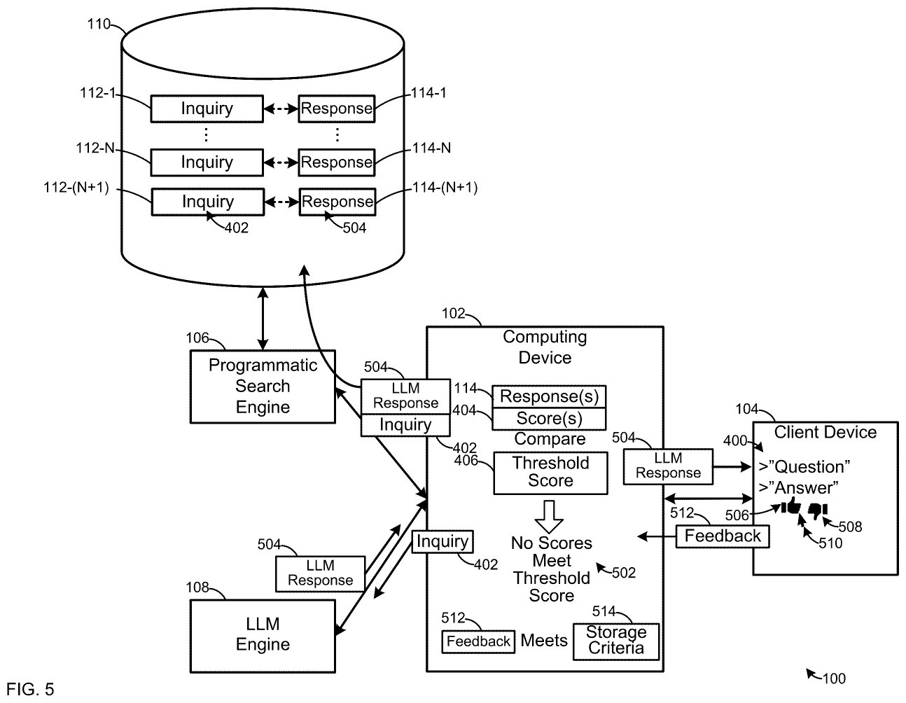

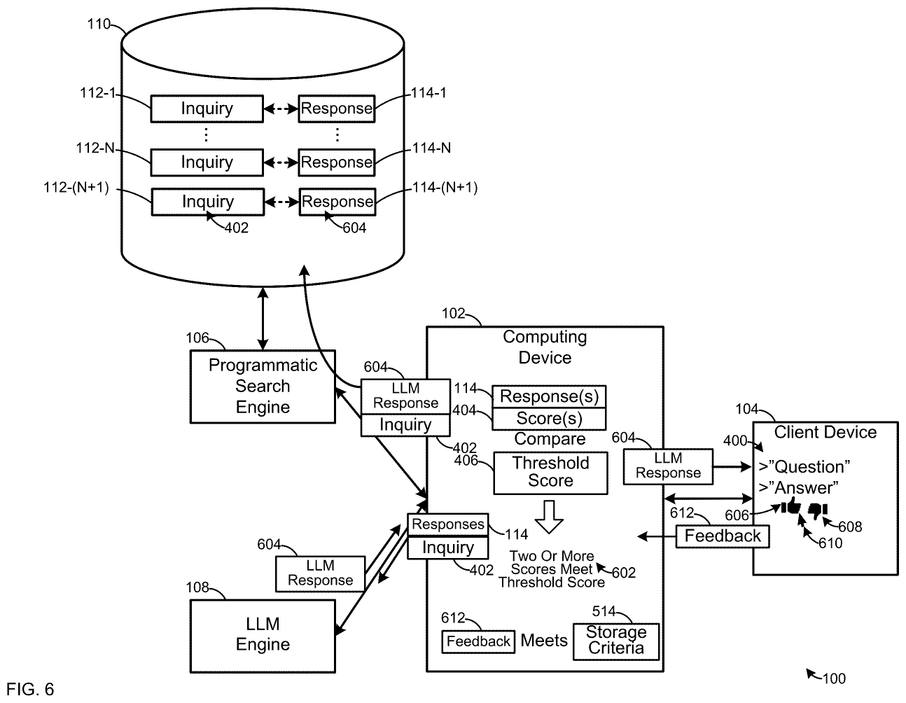

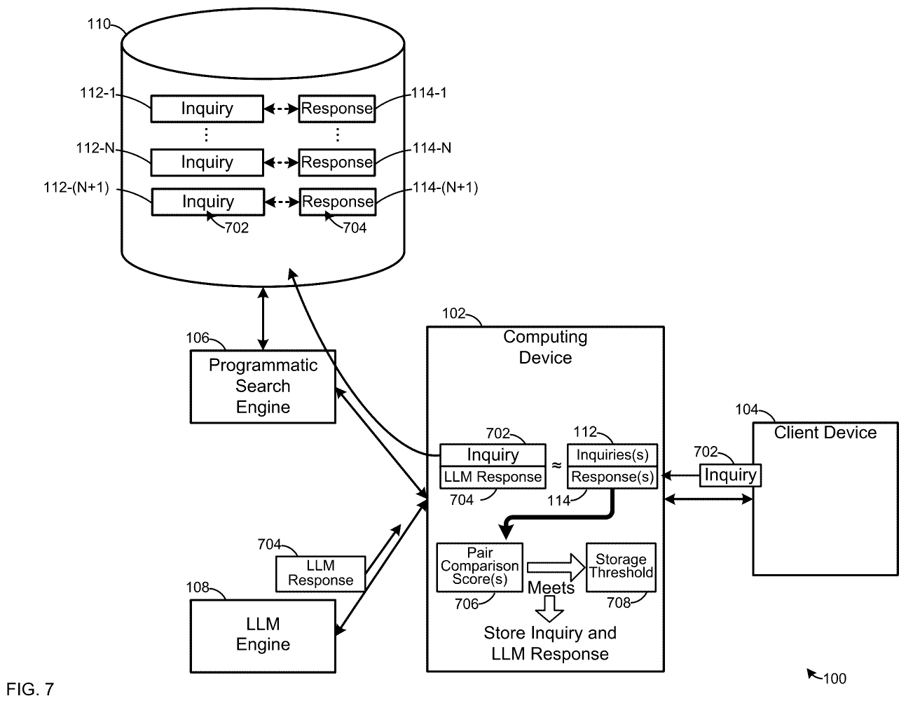

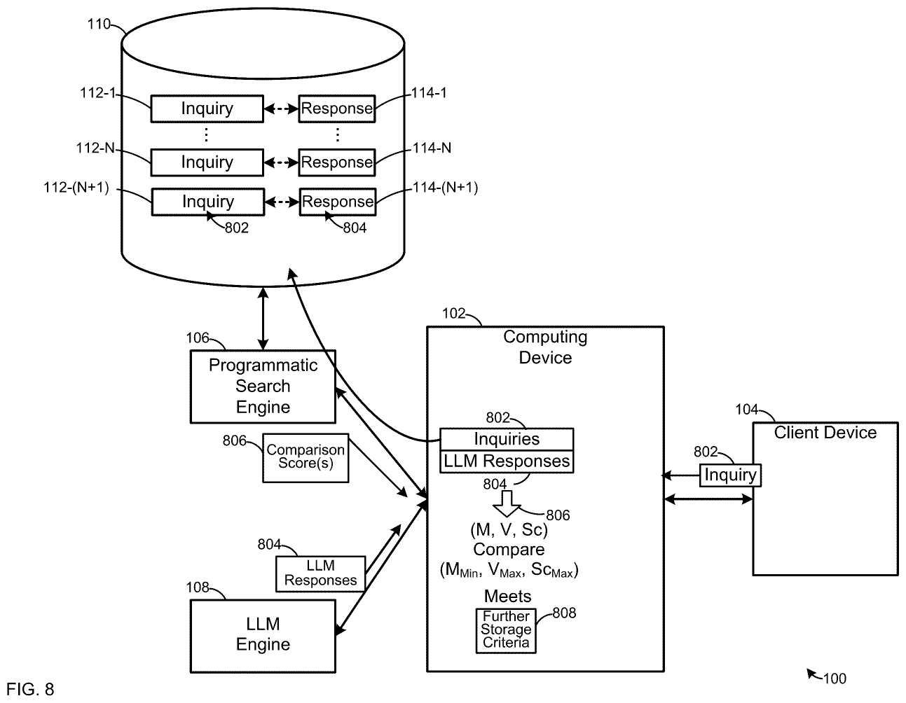

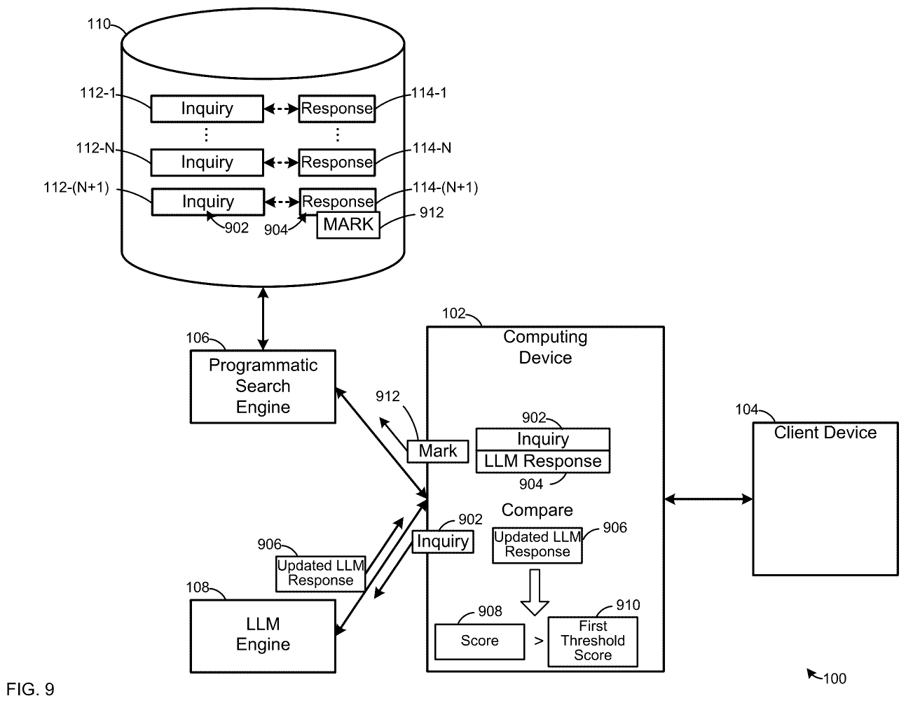

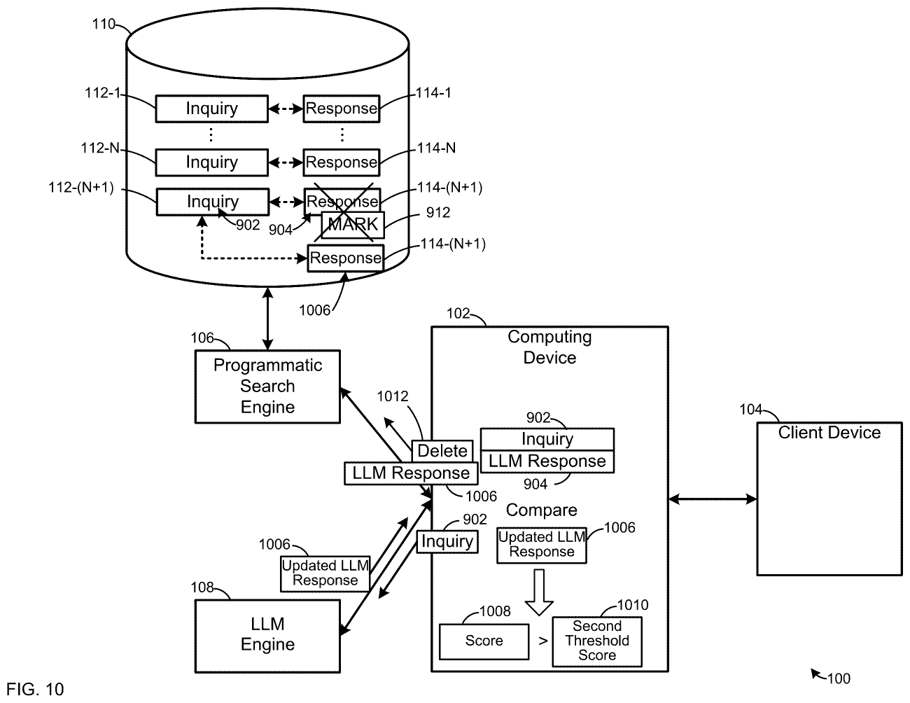

Attention is next directed to FIG. 4, FIG. 5, FIG. 6, FIG. 7, FIG. 8, FIG. 9, and FIG. 10, which depict an example of the method 300. FIG. 4, FIG. 5, FIG. 6, FIG. 7, FIG. 8, FIG. 9, and FIG. 10 are substantially similar to FIG. 1, with like components having like numbers.

Attention is first directed to FIG. 4, which depicts the client device 104 interacting with the computing device 102 via a GUI 400, for example provided at a display screen of the client device 104. For example, a “Question” is received at the GUI 400, and the client device 104 provides the “Question” to the computing device 102 as a textual inquiry 402. The computing device 102 receives (e.g., at the block 302 of the method 300) the textual inquiry 402 and provides (e.g., at the block 304 of the method 300) the textual inquiry 402 to the programmatic search engine 106.

The programmatic search engine 106 uses the textual inquiry 402 to search the textual inquiries 112 stored at the memory 110, to find one or more respective related textual responses 114, which are assigned respective comparison scores 404, and returned to the computing device 102. The computing device 102 receives (e.g., at the block 306 of the method 300) the one or more respective related textual responses 114 with the respective comparison scores 404 and compares the respective comparison scores 404 to a threshold score 406. While not depicted, the programmatic search engine 106 may also provide, to the computing device 102, the textual inquiries 112 corresponding to the one or more respective related textual responses 114 provided to the computing device 102.

Based on the respective comparison scores 404, the computing device 102 provides (e.g., at the block 308) at least the textual inquiry 402 to the LLM engine 108, as is next described with respect to FIG. 5 and FIG. 6.

For example, FIG. 5 depicts a scenario where the computing device 102 determines 502 that no comparison scores 404 meet the threshold score 406. In this example, the computing device 102 provides (e.g., at the block 308 of the method 300) the textual inquiry 402 to the LLM engine 108 without the received related textual responses 114 and receives (e.g., at the block 310), an LLM response 504 from the LLM engine 108 in response. The computing device 102 provides (e.g., at the block 312 of the method 300) the LLM response 504 to the client device 104, where the LLM response 504 is provided at the GUI 400 as an “Answer” to the “Question”.

As depicted the “Answer” that comprises the LLM response 504 is provided with (e.g., thumbs up and thumbs down) electronic buttons 506, 508 that, when respectively selected at the client device 104, represent positive or negative feedback.

For example, as depicted, a cursor 510 is being used to select the “thumbs up” electronic button 506, and feedback 512 is responsively provided from the client device 104 to the computing device 102. The feedback 512 is understood to indicate that the LLM response 504 is approved. Hence, the computing device 102 receives (e.g., at the block 314 of the method 300) the feedback 512, determines that the feedback 512 meets storage criteria 514 (e.g., a “YES” decision at the block 316 of the method 300), and responsively provides (e.g., at the block 318 of the method 300) the textual inquiry 402 and the LLM response 504 to the programmatic search engine 106. The programmatic search engine 106 stores the textual inquiry 402 and the LLM response 504 at the memory 110 as a respective new textual inquiry 112-(N+1), and a respective new associated textual response 114-(N+1).

In contrast, FIG. 6 depicts a scenario where the computing device 102 determines 602 that two or more comparison scores 404 meet the threshold score 406. In this example, the computing device 102 provides (e.g., at the block 308 of the method 300) the textual inquiry 402 to the LLM engine 108 with the two or more received related textual responses 114 having corresponding comparison scores 404 that meet the threshold score 406 and receives (e.g., at the block 310) an LLM response 604 from the LLM engine 108 in return.

The LLM response 604 is understood to be a combination of the two or more received related textual responses 114 having corresponding comparison scores 404 that meet the threshold score 406. The computing device 102 provides (e.g., at the block 312 of the method 300) the LLM response 604 to the client device 104, where the LLM response 604 is provided at the GUI 400 as an “Answer” to the “Question”.

As depicted the “Answer” that comprises the LLM response 604 is provided with (e.g., thumbs up and thumbs down) electronic buttons 606, 608 that, when respectively selected at the client device 104, represent positive or negative feedback.

For example, as depicted, a cursor 610 is being used to select the select the “thumbs up” electronic button 606, and feedback 612 is responsively provided from the client device 104 to the computing device 102. The feedback 612 is understood to indicate that the LLM response 604 is approved. Hence, the computing device 102 receives (e.g., at the block 314 of the method 300) determines that the feedback 612 meets storage criteria 514 (e.g., a “YES” decision at the block 316 of the method 300), and responsively provides (e.g., at the block 318 of the method 300) the textual inquiry 402 and the LLM response 604 to the programmatic search engine 106. The programmatic search engine 106 stores the textual inquiry 402 and the LLM response 604 at the memory 110 as a respective new textual inquiry 112-(N+1), and a respective new associated textual response 114-(N+1).

Attention is next directed to FIG. 7, which depicts an example of the method 300 in instances where a textual inquiry 702 is received from the client device 104 and a corresponding LLM response 704 is received from the LLM engine 108. It is understood in this example that, while not depicted, the LLM response 704 has been provided to the client device 104 and positive feedback has been returned that meets the storage criteria 514, as seen in both FIG. 5 and FIG. 6. Also depicted in FIG. 7 at the computing device 102 are the one or more textual responses 114 that met the threshold score 406 and the corresponding textual inquiries 112 as received from the programmatic search engine 106.

However, in this example, prior to the textual inquiry 702 and the LLM response 704 being stored at the memory 110, the pair of the textual inquiry 702 and the LLM response 704 are compared (e.g., as represented by the symbol “˜”) to pairs of the textual inquiries 112 and the textual responses 114 to determine respective one or more respective pair comparison scores 706, that are compared to a given storage threshold 708. When, as depicted) one or more one or more respective pair comparison scores 706 meet the given storage threshold 708 (e.g., such as when a smallest respective pair comparison score 706 is less than the given storage threshold 708, or when an average of the respective pair comparison scores 706 is less than the given storage threshold 708 and/or when a given number of the respective pair comparison scores 706 is less than the given storage threshold 708), the computing device 102 provides (e.g., as depicted) the pair of the textual inquiry 702 and the LLM response 704 to the programmatic search engine 106 for storage at the memory 110 as a respective new textual inquiry 112-(N+1), and a respective new associated textual response 114-(N+1).

Attention is next directed to FIG. 8, which depicts an example of the method 300 in instances where a plurality of textual inquiries 802 are received at the computing device 102 (e.g., that may include, as depicted, at least one textual inquiry 802 from the client device 104), and corresponding LLM responses 804 are received from the LLM engine 108. It is understood in this example that, while not depicted, the LLM responses 804 have been provided to respective client devices (e.g., such as the client device 104) and positive feedback has been returned that meets the storage criteria 514, as seen in both FIG. 5 and FIG. 6.

In general, the textual inquiries 802 and corresponding LLM responses 804 are collected at the computing device 102 over a given time period.

The textual inquiries 802 and corresponding LLM responses 804 are furthermore understood to relate to a given topic, as determined by comparing the textual inquiries 802. Put another way, at least the textual inquiries 802 are understood to be similar.

As depicted in FIG. 8, the textual inquiries 802 and corresponding LLM responses 804 are processed 806 to determine a number M of pairs of the textual inquiries 802 and corresponding LLM responses 804, a variance V thereof, and a total comparison score Sc between the textual inquiries 802 and corresponding LLM responses 804 and the stored textual inquiries 112 and the respective related textual responses 114 (e.g., that may be determined in a manner similar to as described with respect to FIG. 7 (e.g., the total comparison score Sc may represent an average of the pair comparison scores 706, and the like).

As depicted, the number M, variance V, and total comparison score Sc are compared to respective thresholds M_{Min}, V_{Max} and Sc_{Max}, and, as depicted, the computing device 102 determines that one or more further storage criteria 808 are met (e.g., the number M is above respective threshold M_{Min}, and/or the variance V is less than V_{Max}, and/or, the and total comparison score Sc is less than Sc_{Max}). As such, the computing device 102 responsively communicates with the programmatic search engine 106 to control the programmatic search engine 106 to store the textual inquiries 802 and corresponding LLM responses 804 (and/or an “average” thereof, determined by the computing device 102 providing the textual inquiries 802 and corresponding LLM responses 804 to the LLM engine 108) at the memory 110 as a respective one or more new textual inquiries 112-(N+1), and a one or more respective new associated textual responses 114-(N+1).

Attention is next directed to FIG. 9, that depicts the computing device 102 processing a textual inquiry 902 and a corresponding LLM response 904 that has been stored at the memory 110 as a respective textual inquiry 112-(N+1), and respective associated textual response 114-(N+1). In particular, while not depicted, the computing device 102 may retrieve the textual inquiry 902 and a corresponding LLM response 904 from the memory 110 via the programmatic search engine 106 and provide the textual inquiry 902 to the LLM engine 108 to responsively receive an updated LLM response 906 that is compared to the LLM response 904 to determine a respective difference comparison score 908 (e.g., where “0” represents no difference and/or a minimum difference between the LLM responses 904, 906, and “100” representing a worst difference and/or a maximum difference between the LLM responses 904, 906).

As depicted, the respective difference comparison score 908 is compared to a first threshold score 910. As depicted, the comparison score 908 is understood to be above the first threshold score 910 and, as such, the computing device 102 provides an indication 912 to the programmatic search engine 106 to “MARK” the pair of the textual inquiry 902 and the corresponding LLM response 904 stored at the memory 110 as the respective textual inquiry 112-(N+1), and the respective associated textual response 114-(N+1). For example, as depicted, the indication 912 of “MARK” is stored at the memory 110 at the respective associated textual response 114-(N+1). In general, the indication 912 indicates that answers to the textual inquiry 902 are drifting at the LLM engine 108, but are not yet different enough to delete at least the LLM response 904 from the memory 110. Nonetheless, the indication 912 may cause the computing device 102 to periodically follow up on changes to the LLM engine 108 generation of responses to the textual inquiry 902, for example at a higher periodicity than other textual responses 114 stored at the memory 110 that are not marked.

Attention is next directed to FIG. 10, which is understood to follow in time from FIG. 9. In particular, the computing device 102 again uses the inquiry 902 to generate yet a further updated LLM response 1006 via the LLM engine 108, and compares the LLM responses 904, 1006 to generate a difference comparison score 1008. The difference comparison score 1008 is compared to a second threshold score 1010 higher than the first threshold score 910.

As depicted, the difference comparison score 1008 is understood to be above the second threshold score 1010 and, as such, the computing device 102 provides a command 1012 to the programmatic search engine 106 to delete at least the LLM response 904 stored at the memory 110 as the respective associated textual response 114-(N+1). Such a deletion is indicated by a respective “X” through the respective associated textual response 114-(N+1) (as well as the indication 912). In general, the difference comparison score 1008 being above the second threshold score 1010 indicates that responses generated by the LLM engine 108 in response to the inquiry 902 have drifted far from the original response 904, such that the original response 904 is considered to no longer be a valid response to the textual inquiry 902.

While the textual inquiry 902 in the form of the respective associated textual response 114-(N+1) may also be deleted from the memory 110, as depicted, the further updated LLM response 100 6 may be provided to the programmatic search engine 106 with the command 1012 such that the further updated LLM response 100 6 replaces the former LLM response 904 as the respective associated textual response 114-(N+1). In particular the further updated LLM response 100 6 may represent a more current answer to the inquiry 902 than the LLM response 904.

Returning briefly to FIG. 9, in some examples, it is understood that the updated LLM response 906 of FIG. 9 may cause the comparison score 908 to be above the second threshold score 1010. In these examples, the example depicted in FIG. 10 may occur, but with the updated LLM response 906 rather than the further updated LLM response 100 6 such that the updated LLM response 906 of FIG. 9 is used to replace the former LLM response 904 as the respective associated textual response 114-(N+1).

Yet further aspects are within the scope of the present specification.

For example, over time, various inquires 112 may accumulate that are related to a same and/or similar topic. However, in some examples, associated responses 114 may contradict each other. For example, in different implementations of the method 300 with different client devices 104 providing similar inquiries, different responses may be returned (e.g., from the LLM engine 108) that are contradictory and/or inconsistent, and the different client devices 104 may return respective feedback indicating that the different responses are approved. As such, the memory 110 may, over time, get populated with contradictory and/or inconsistent responses 114 to syntactically related inquiries 112.

Put another way, the generation of the comparison scores 404 between inquiries are generally generated syntactically. As in some instances contradictory and/or inconsistent responses 114 may be populated at the memory 110, as is next described, semantic analysis may be used to resolve such contradictory and/or inconsistent responses 114.

Indeed, it is generally understood that in the method 300, generation of the comparison scores 404 between inquiries are generally generated syntactically and generation of LLM responses by the LLM engine 108 are generated semantically. Such techniques may hence be extended to resolving contradictions and/or inconsistencies as is next described.

For example, periodically, and/or upon generation of a new response 114, the inquiries 112 may be compared syntactically to find subsets of two or more related inquiries 112, for example similar to comparing the scores 404 to the threshold score 406 as described with reference to FIG. 6.

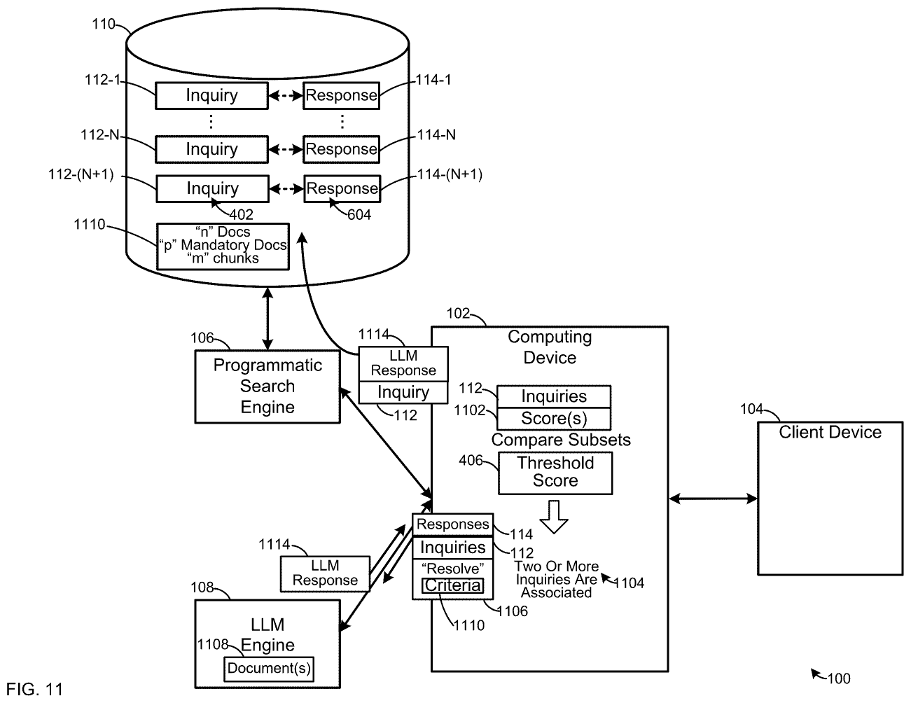

Indeed, attention is next directed to FIG. 11, which depicts the computing device 102 comparing inquiries 112 to determine comparison scores 1102 therebetween, similar to the scores 404. The scores 1102 are compared to the threshold score 406 to determine 1104 that two or more of the inquiries 112 are associated, for example when two or more of the inquiries 112 are determined (e.g., syntactically) to have comparison scores 1102 that meet the threshold score 406.

In these examples, as depicted, the associated responses 114, and the associated inquiries 112, are provided to the LLM engine 108 with a query 1106 to resolve any contradictory and/or inconsistent responses 114.

Hence, in these examples, in comparison to FIG. 6, rather than providing the associated responses 114 to the LLM engine 108 to generate an LLM response 604 that merely combines the associated responses 114, the associated responses 114 may be provided to the LLM engine 108 with the query 1106 to control the LLM engine 108 to semantically analyze the associated responses 114 for contradictions and/or inconsistencies, and resolve the contradictions and/or inconsistencies.

In these examples, it is understood that the LLM engine 108 may be trained on, and/or have access to, various documents 1108 that may be used to generate LLM responses. However, in some examples, the various documents 1108 may themselves be used to generate LLM responses that may contradict each other and, indeed, it is such contradictions that may lead to responses 114 stored in the memory 110 being contradictory and/or inconsistent.

Furthermore, as depicted, the memory 110 may be optionally updated according to the example of FIG. 11 to include criteria 1110 for resolving contradictions and/or inconsistencies that may be provided to the LLM engine 108 in the query 1106. For example, as depicted, the criteria 1110 indicate that, when resolving contradictions and/or inconsistencies, the LLM engine 108 is to use at least an “n” number of the documents 108, and specifically use a “p” number of mandatory documents 108 (e.g., which may be also be identified in the criteria 1110 (e.g., with “p” being less than “n”). As depicted, the criteria 1110 may further specify that a maximum of “m” chunks per document 1108 may be selected to resolve the contradictions and/or inconsistencies.

It is understood that the numbers “n”, “p” and “m” may be selected by an administrator of the system 100, and may assume a knowledge of a total number of the documents 1108 and a knowledge of the documents 1108 that are available. As such “n” may be selected to be less than or equal to the total number of the documents 1108, and “p” may be less than or equal to “n”, with “p” or fewer specific documents 1108 identified in the criteria 1110.

It is understood that, with respect to the LLM engine 108 (and/or large language models in general), the term “chunks” may include discrete segments of text of a document 1108 and/or input to the LLM engine 108, the discrete segments of text generated by the LLM engine 108 by splitting a document 1108 and/or input based on token limits, sentence boundaries, and/or semantic coherence.

A number of “m” chunks may also be selected heuristically, such that only a maximum “m” number of chunks of any given document 1108 used to resolve the contradictions and/or inconsistencies. For example the “m” most relevant chunks may be used, and “m” may be less than a total number of chunks for a given document 1108. Determining relevancy of chunks is understood to be known to persons of skill in the art and is understood to be based on how well a specific chunk aligns (e.g., semantically) with input to the LLM engine 108, such as how well the combination of the responses 114 and associated inquiries 112, that is provided to the LLM engine 108, align with such chunks.

However, it is understood that use of the criteria 1110 may be optional and/or, of the depicted three criteria 1110, as few as one of the criteria 1110 may be used, or two of the criteria 1110 may be used, or all three of the criteria 1110 may be used. When fewer than three criteria 1110 are specified, any suitable one or any suitable two of the criteria 1110 may be used in any suitable combination. Similarly, while three criteria 1110 are depicted, fewer than three criteria 1110 may be specified or more than three criteria 1110 may be specified.

Regardless of whether the criteria 1110 is used or not, as depicted the LLM engine 108 may return an LLM response 1114 that may resolve the contradictions and/or inconsistencies of the responses 114 provided to the LLM engine 108 and which may be based at least in part on the criteria 1110.

In a simple example, various inquiries 112 may be indicate in syntactically related ways as to how many eggs to use per person in an omelet (“How many eggs to use in an omelet for one person”, “What number of eggs should go into an omelet just for myself”, etc.), and associated responses 114 may indicate different numbers of eggs per person (e.g., “two eggs”, “four eggs”, etc.). As such, the inquiries 112 related to asking how many eggs to use per person in an omelet may be determined to have scores 1102 that meet the threshold score 406, and the associated responses 114, the inquiries 112, the query 1106, (and, optionally, the criteria 1110), may be provided to the LLM engine 108. Furthermore, in examples where the criteria 1110 are provided, the documents 1108 may include digital cookbooks, and the like, and the criteria 1110 may indicate that four (e.g., “n=4”) maximum of the documents 1108 should be used, including at least one (e.g., “p=1”) mandatory document 1108 (e.g., a specified cookbook), with at maximum three chunks (e.g., “m=3”) used per document 1108 (e.g., of each of the four documents 1108) to resolve the contradictions and/or inconsistencies.

Indeed, in these examples, the LLM engine 108 may generate an LLM response 1114 that resolves the contradictions and/or inconsistencies. Continuing with the example of a number of eggs per person in an omelet, the LLM response 1114 may indicate “two eggs” per person, and the like based on more of the documents 1108 indicating two eggs than four eggs. As depicted, the LLM response 1114 and one of the associated inquiries 112 may be used to replace the responses 114 and associated inquiries 112 at the memory 110 that were contradictory.

Returning to the criteria 1110, it is understood that as “n” increases, source diversity increases, which may cause an accuracy of the LLM response 1114 to increase.

Similarly, it is understood that when a “p” number of mandatory documents 1108 is indicated, accuracy and reliability of the LLM response 1114 may be increased by ensuring that the most important and/or most accurate documents 1108 are considered.

It is understood that when “m” number of chunks per document 1108 is indicated, a time to generate the LLM response 1114 may be decreased as compared to when all chunks are considered (e.g., assuming that “m” is smaller than a total number of chunks per document 1108).

The example of FIG. 11 may be further refined. For example, when two or more of the inquiries 112 were found to have similarity scores 1102 that meet the threshold score 406, similarity scores between the associated responses 114 may also be determined at the computing device 102 by syntactic comparison of the text of the associated responses 114. Such similarity scores may be compared to a threshold score that may be the same as, or different from, the threshold score 406. and when at least one of the associated responses 114 results in a similarity score that does not meet such a threshold score, the computing device 102 may determine that the associated responses 114 are contradictory and/or inconsistent and proceed to provide the responses 114, the associated inquiries 112, the query 1106 and, optionally, the criteria 1110, to the LLM engine 108.

Alternatively, or in addition, the LLM engine 108 may determine a contradiction rate (e.g., a given number of contradictory chunks as compared to a total number of chunks expressed as a fraction and/or a percentage, amongst other possibilities) of the combination of the responses 114 and the associated inquiries 112 provided to the LLM engine 108, and when the contradiction rate is above a threshold contradiction rate, the LLM engine 108 may determine that the responses 114 contradict each other and/or are inconsistent. Such a threshold contradiction rate may be any suitable value programmed at the LLM engine 108 and/or may be provided with the criteria 1110.

Returning to the eggs example, the threshold contradiction rate may be 30%, 40%, 50% (e.g., maximum), amongst other possibilities. For example, when the responses 114 are “two eggs” and “four eggs” and each word corresponds to a chunk, the contradiction rate may be 50%. Assuming that the threshold contradiction rate is 50%, when the contradiction rate is below the threshold contradiction rate (e.g., not the case in the eggs example), the example of FIG. 6 may be implemented and the responses 114 provided to the LLM engine 108 may be combined by the LLM engine 108 to generate the LLM response 604. However, when the contradiction rate is at or above the threshold contradiction rate (e.g., as in the eggs example), the example of FIG. 11 may be implemented, the LLM engine 108 may classify the responses 114 as contradictory and/or inconsistent, and the LLM engine 108 may generate the LLM response 1114 that resolves such contradictions and/or inconsistencies.

Alternatively, or in addition, the contradiction rate may be determined from contradictory chunks of the documents 1108 that are determined to be relevant to the responses 114. Returning to the eggs example, one or more documents 1108 may indicate 2 eggs per person at relevant chunks (e.g., as determined from the inquiry 112 provided to the LLM engine 108), and another document 1108 may indicate 4 eggs per person at relevant chunks. In these examples, and assuming that contradiction rate is determined from a given number of contradictory chunks as compared to a total number of “m” chunks of a given document 1108 (e.g., expressed as a fraction and/or a percentage, amongst other possibilities) the threshold contradiction rate may be adjusted accordingly, such as 20%, 25%, 30%, amongst other possibilities. When the contradiction rate is below the threshold contradiction rate, the example of FIG. 6 may be implemented and the responses 114 provided to the LLM engine 108 may be combined by the LLM engine 108 into the LLM response 604. However, when the contradiction rate is at or above the threshold contradiction rate, the example of FIG. 11 may be implemented, the LLM engine 108 may classify the responses 114 as contradictory and/or inconsistent, and the LLM engine 108 generates the LLM response 1114 that resolves such contradictions and/or inconsistencies.

In yet further particular examples, the method 300 may be adapted as is next described.

Using the method 300, a new pair of an inquiry 112 and a respective response 114 may be determined. For example, with reference to FIG. 5, such a new pair of an inquiry 112 and a respective response 114 may comprise the inquiry 402 and the LLM response 504. Furthermore, in these examples, it is understood that the new pair of an inquiry 112 and a respective response 114 may be syntactically similar to one or more other pairs of inquiries 112 and respective responses 114 already stored at the memory 110, forming syntactically similar group of inquiries 112 and respective responses 114.

The computing device 102 may identify such a syntactically similar group of inquiries 112 and respective responses 114 using comparison scores 404 and the threshold score 406 as has been previously described (e.g., by syntactically comparing inquiries 112, which is understood to include, but is not limited to, the inquiry 402). For simplicity and compactness, hereafter, pairs of inquiries 112 and respective responses 114 in the syntactically similar group are hereafter referred to as entries in the group, with the new pair of an inquiry 112 and a respective response 114 being referred to as the new entry, and previously stored pairs of inquiries 112 and respective responses 114 being referred to as existing entries. Also for compactness, hereafter, references to entries being in contradiction is understood to include, the entries being inconsistent.

Furthermore, such classification may occur as using to the criteria 1110 as described herein.

The computing device 102 may provide the syntactically similar group of entries to the LLM engine 108 with a query, similar to the query 1106, that controls the LLM engine 108 to compare the new entry with the previous entries to classify each of the previous entries as being in contradiction the new entry or not in contradiction with the new entry. In particular responses of the entries are semantically compared to determine contradictions. For example, each of the previous entries may be classified as “YES” (e.g., being in contradiction with the new entry) or “NO” (e.g., not being in contradiction with the new entry). Such classification may occur via the LLM engine 108 applying semantic analysis when comparing the new entry with the previous entries. However, any suitable indicators may be used to classify a previous entry as being contradictory or not contradictory with the new entry.

Furthermore, the LLM engine 108 may return the classifications of the previous entries to the computing device 102, which may determine a contradiction rate for the group, which, in these examples, may be determined from:

$$Contradiction Rate = \frac{Number of entries classified as contradictory}{Total number of entries} \qquad Equation ( 1 )$$

In these examples the “Number of entries classified as contradictory” is understood to refer to the number of previous entries classified as contradictory. Similarly, the “Total number of entries” is understood to refer to the total number of previous entries. Hence, according to Equation (1), the contradiction rate may comprise the fraction and/or a percentage of the total number of previous entries classified as contradictory with the new entry.

The contradiction rate meeting, or not meeting, a threshold contradiction rate may be used to determine whether or not to store the new entry at the memory 110.

For example, using Equation (1) expressed as a percentage as a basis, the threshold contradiction rate may be set at 5%, 10%, 15%, amongst other possibilities, and may be selected heuristically to be low enough to ensure that only new entries that have a low contradiction rate are stored to the memory 110. Indeed, the new entry being associated with a contradiction rate at or below the threshold contradiction rate may be one of the storage criteria 514. Hence, when the new entry is associated with a contradiction rate at or below the threshold contradiction rate (e.g., a “YES” decision at the block 316), the new entry may be stored at the memory 110 (e.g., at the block 318). However, when the new entry is associated with a contradiction rate above the threshold contradiction rate (e.g., a “NO” decision at the block 316), the new entry may be discarded (e.g., at the block 320).

Such a determination of contradiction rate may further occur before or after receipt of feedback of an LLM response provided to the client device 104, and/or before or after providing an LLM response to the client device 104.

Alternatively, the new entry and existing entries that are classified as being not contradictory may be combined to generate a new entry for the memory 110 similar to as described with respect to FIG. 6.

Hence, even more specifically, the method 300 may further comprise, after receiving an LLM response at the block 310: syntactically comparing the textual inquiry with previously stored textual inquiries to identify a group of one or more inquiries that are syntactically related to the textual inquiry; providing a pair of the textual inquiry and the LLM response with the group of the one or more inquiries and respective responses to the LLM engine 108 to cause the LLM engine 108 to classify the respective response in the group as being contradictory or not contradictory with the LLM response; determining a contradiction rate from classifications of the respective responses; and when the contradiction rate is below a threshold contradiction rate, providing, to the programmatic search engine 106, the textual inquiry and the LLM response for storage and use in generating responses to later textual inquiries.

As should by now be apparent, the operations and functions of the devices described herein are sufficiently complex as to require their implementation on a computer system, and cannot be performed, as a practical matter, in the human mind. In particular, computing devices, and the lie, such as set forth herein are understood as requiring and providing speed and accuracy and complexity management that are not obtainable by human mental steps, in addition to the inherently digital nature of such operations (e.g., a human mind cannot interface directly with, RAM or other digital storage, cannot transmit or receive electronic messages, generate LLM responses, cannot operate machine learning feedback loops, among other features and functions set forth herein).

It is further understood that instance of the term “configured to”, such as “a computing device configured to . . . ”, “a processor configured to . . . ”, “a controller configured to . . . ”, and the like, may be understood to include a feature of a computer-readable storage medium having stored thereon program instructions that, when executed by a computing device and/or a processor and/or a controller, and the like, may cause the computing device and/or the processor and/or the controller to perform a set of operations which may comprise the features that the computing device and/or the processor and/or the controller, and the like, are configured to implement. Hence, the term “configured to” is understood not to be unduly limiting to means plus function interpretations, and the like.

Furthermore, descriptions of one processor and/or controller and/or device and/or engine, and the like, configured to perform certain functionality is understood to include, but is not limited to, more than one processor and/or more than one controller and/or more than one device and/or more than one engine, and the like performing such functionality.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, XZ, and the like). Similar logic may be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that in some examples, the functionality of devices and/or methods and/or processes described herein may be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein may be achieved using a computing apparatus that has access to a code memory (not shown), which stores computer-readable program code for operation of the computing apparatus. The computer-readable program code could be stored on a computer readable storage medium, which is fixed, tangible and readable directly by these components, (e.g., removable diskette, CD-ROM, ROM, fixed disk, USB drive). Furthermore, it is appreciated that the computer-readable program may be stored as a computer program product comprising a computer usable medium. Further, a persistent storage device may comprise the computer readable program code. It is yet further appreciated that the computer-readable program code and/or computer usable medium may comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium may be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative examples and modifications possible, and that the above examples are only illustrations of one or more examples. The scope, therefore, is only to be limited by the claims appended hereto.

What is claimed is:

1. A method comprising:
receiving, at a computing device, from a client device, a textual inquiry;
providing, via the computing device, the textual inquiry to a programmatic search engine that compares the textual inquiry to previously stored textual inquiries, the previously stored textual inquiries stored in association with respective related textual responses;
receiving, via the computing device, from the programmatic search engine, one or more of the respective related textual responses with respective comparison scores between the textual inquiry and associated stored textual inquiries;
based on the respective comparison scores, providing, via the computing device, at least the textual inquiry to a large language model (LLM) engine;
receiving, via the computing device, from the LLM engine, an LLM response to the textual inquiry;
providing, via the computing device, to the client device, the LLM response;
receiving, via the computing device, from the client device, feedback on the LLM response; and
when the feedback meets a storage criteria, providing, via the computing device, to the programmatic search engine, the textual inquiry and the LLM response for storage and use in generating responses to later textual inquiries.

2. The method of claim 1, further comprising, after receiving the LLM response:
syntactically comparing the textual inquiry with previously stored textual inquiries to identify a group of one or more inquiries that are syntactically related to the textual inquiry;
providing a pair of the textual inquiry and the LLM response with the group of the one or more inquiries and respective responses to the LLM engine to cause the LLM engine to classify the respective response in the group as being contradictory or not contradictory with the LLM response;
determining a contradiction rate from classifications of the respective responses; and
when the contradiction rate is below a threshold contradiction rate, providing, to the programmatic search engine, the textual inquiry and the LLM response for storage and use in generating responses to later textual inquiries.

3. The method of claim 1, further comprising:
comparing the respective comparison scores to a threshold score; and
when none of the respective comparison scores meet the threshold score, providing the textual inquiry to the LLM engine comprises: providing the textual inquiry to the LLM engine without any of the respective related textual responses.

4. The method of claim 1, further comprising:
comparing the respective comparison scores to a threshold score; and
when two or more of the respective comparison scores meet the threshold score, providing the textual inquiry to the LLM engine comprises: providing the textual inquiry to the LLM engine with the respective related textual responses associated with the two or more of the respective comparison scores meet the threshold score.

5. The method of claim 1, further comprising:
comparing the respective comparison scores to a threshold score; and
when two or more respective comparison scores meet the threshold score, providing the textual inquiry to the LLM engine comprises: providing the textual inquiry to the LLM engine with the respective related textual responses associated with the two or more respective comparison scores meet the threshold score such that the LLM response comprises an LLM generated combination of the respective related textual responses associated with the two or more respective comparison scores meet the threshold score.

6. The method of claim 1, further comprising:
comparing a pair of the textual inquiry and the LLM response to pairs of the previously stored textual inquiries and the respective related textual responses to determine respective pair difference comparison scores between the pair and the pairs, and
wherein providing, to the programmatic search engine, the textual inquiry and the LLM response for storage is further based on one or more of the respective pair difference comparison scores.

7. The method of claim 6, wherein providing, to the programmatic search engine, the textual inquiry and the LLM response for storage occurs when a smallest respective pair difference comparison score is less than a given pair storage threshold score.

8. The method of claim 6, wherein providing, to the programmatic search engine, the textual inquiry and the LLM response for storage occurs when an average of the respective pair difference comparison scores is less than a given pair storage threshold score.

9. The method of claim 6, wherein providing, to the programmatic search engine, the textual inquiry and the LLM response for storage occurs when a given number of the respective pair difference comparison scores is less than a given pair storage threshold score.

10. The method of claim 1, further comprising, prior to providing the textual inquiry and the LLM response for storage:
collecting, for a given time period, one or more associated textual inquiries and respective LLM responses, including the textual inquiry and the LLM response, that meet the storage criteria;
determining one or more of: a number of the one or more associated textual inquiries; a variance between the respective LLM responses; and a total comparison score representing a comparison between the one or more associated textual inquiries and the respective LLM responses, and the associated stored textual inquiries and the respective related textual responses;
comparing one or more of the number, the variance and the total comparison score to respective thresholds; and
when the comparing meets a further storage criteria, providing, to the programmatic search engine, the one or more associated textual inquiries and the respective LLM responses, including the textual inquiry and the LLM response, for storage.

11. The method of claim 1, further comprising, after the textual inquiry and the LLM response are stored:
again providing the textual inquiry to the LLM engine, and receiving an updated LLM response;
comparing the LLM response and the updated LLM response to determine a respective difference comparison score therebetween;
when the respective difference comparison score is above a first threshold: marking the LLM response as deteriorated; and thereafter periodically generating the updated LLM response and again determining the respective difference comparison score therebetween; or
when the respective difference comparison score is above a second threshold, larger than the first threshold, controlling the programmatic search engine to delete at least the LLM response.

12. The method of claim 1, wherein a memory, accessible by the programmatic search engine, that stores the previously stored textual inquiries in association with respective related textual responses is initially empty, and the method further comprises:
populating the memory with one or more textual inquiries from one or more client devices and associated LLM responses from the LLM engine.

13. A computing device comprising:
a communication interface;
a controller; and
a computer-readable storage medium having stored thereon program instructions that, when executed by the controller, cause the controller to perform a set of operations comprising:
receiving, from a client device, a textual inquiry;
providing the textual inquiry to a programmatic search engine that compares the textual inquiry to previously stored textual inquiries, the previously stored textual inquiries stored in association with respective related textual responses;
receiving, from the programmatic search engine, one or more of the respective related textual responses with respective comparison scores between the textual inquiry and associated stored textual inquiries;
based on the respective comparison scores, providing at least the textual inquiry to a large language model (LLM) engine;
receiving, from the LLM engine, an LLM response to the textual inquiry;
providing, to the client device, the LLM response;
receiving, from the client device, feedback on the LLM response; and
when the feedback meets a storage criteria, providing, to the programmatic search engine, the textual inquiry and the LLM response for storage and use in generating responses to later textual inquiries.

14. The computing device of claim 13, wherein the set of operations further comprises, after receiving the LLM response:
syntactically comparing the textual inquiry with previously stored textual inquiries to identify a group of one or more inquiries that are syntactically related to the textual inquiry;
providing a pair of the textual inquiry and the LLM response with the group of the one or more inquiries and respective responses to the LLM engine to cause the LLM engine to classify the respective response in the group as being contradictory or not contradictory with the LLM response;
determining a contradiction rate from classifications of the respective responses; and
when the contradiction rate is below a threshold contradiction rate, providing, to the programmatic search engine, the textual inquiry and the LLM response for storage and use in generating responses to later textual inquiries.

15. The computing device of claim 13, wherein the set of operations further comprises:
comparing the respective comparison scores to a threshold score; and
when none of the respective comparison scores meet the threshold score, providing the textual inquiry to the LLM engine comprises: providing the textual inquiry to the LLM engine without any of the respective related textual responses.

16. The computing device of claim 13, wherein the set of operations further comprises:
comparing the respective comparison scores to a threshold score; and
when two or more of the respective comparison scores meet the threshold score, providing the textual inquiry to the LLM engine comprises: providing the textual inquiry to the LLM engine with the respective related textual responses associated with the two or more of the respective comparison scores meet the threshold score.

17. The computing device of claim 13, wherein the set of operations further comprises:
comparing the respective comparison scores to a threshold score; and
when two or more respective comparison scores meet the threshold score, providing the textual inquiry to the LLM engine comprises: providing the textual inquiry to the LLM engine with the respective related textual responses associated with the two or more respective comparison scores meet the threshold score such that the LLM response comprises an LLM generated combination of the respective related textual responses associated with the two or more respective comparison scores meet the threshold score.

18. The computing device of claim 13, wherein the set of operations further comprises:
comparing a pair of the textual inquiry and the LLM response to pairs of the previously stored textual inquiries and the respective related textual responses to determine respective pair difference comparison scores between the pair and the pairs, and
wherein providing, to the programmatic search engine, the textual inquiry and the LLM response for storage is further based on one or more of the respective pair difference comparison scores.

19. The computing device of claim 13, wherein the set of operations further comprises, prior to providing the textual inquiry and the LLM response for storage:
collecting, for a given time period, one or more associated textual inquiries and respective LLM responses, including the textual inquiry and the LLM response, that meet the storage criteria;
determining one or more of: a number of the one or more associated textual inquiries; a variance between the respective LLM responses; and a total comparison score representing a comparison between the one or more associated textual inquiries and the respective LLM responses, and the associated stored textual inquiries and the respective related textual responses;
comparing one or more of the number, the variance and the total comparison score to respective thresholds; and
when the comparing meets a further storage criteria, providing, to the programmatic search engine, the one or more associated textual inquiries and the respective LLM responses, including the textual inquiry and the LLM response, for storage.

20. The computing device of claim 13, wherein the set of operations further comprises, after the textual inquiry and the LLM response are stored:
again providing the textual inquiry to the LLM engine, and receiving an updated LLM response;
comparing the LLM response and the updated LLM response to determine a respective difference comparison score therebetween;
when the respective difference comparison score is above a first threshold: marking the LLM response as deteriorated; and thereafter periodically generating the updated LLM response and again determining the respective difference comparison score therebetween; or
when the respective difference comparison score is above a second threshold, larger than the first threshold, controlling the programmatic search engine to delete at least the LLM response.
